(19) United States
(12) Patent Application Publication
(10) Pub. No.: US 2009/0002412 A1
(43) Pub. Date: Jan. 1, 2009

(54) FLUID EJECTING APPARATUS AND FLUID EJECTION CONTROL METHOD USED BY FLUID EJECTING APPARATUS

(75) Inventors: Takayuki KAWAKAMI, Matsumoto-shi (JP); Shinichi KAMOSHIDA, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/147,289

(22) Filed: Jun. 26, 2008

(30) Foreign Application Priority Data
Jun. 27, 2007 (JP) 2007-168675

(51) Int. Cl. B41J 25/308

(52) U.S. Cl. 347/8

(57) ABSTRACT

The invention provides a fluid ejecting apparatus that includes: an apparatus body; and a plurality of fluid ejecting heads that can eject fluid onto a fluid ejection target medium. In the configuration of the fluid ejecting apparatus according to an aspect of the invention, at least one of the plurality of fluid ejecting heads can move in a predetermined direction that intersects the transport direction of the fluid ejection target medium so as to change the relative positions of the plurality of fluid ejecting heads as viewed in the predetermined direction that intersects the transport direction of the fluid ejection target medium.

### BACKGROUND

1. Technical Field

The present invention relates to a fluid ejecting apparatus that is provided with a fluid ejecting head that ejects fluid onto a fluid ejection target medium. In addition, the invention further relates to a fluid ejection control method that is used by such a fluid ejecting apparatus. A non-limiting specific example of the fluid ejecting apparatus is an ink-jet printer, which ejects ink onto a sheet of recording paper from its recording head.

2. Related Art

As an example of various kinds of fluid ejecting apparatuses, an ink-jet printer that discharges ink drops onto a sheet of printing paper from the ink-jet recording head thereof is known in the art. Such a known ink-jet printer is disclosed in, for example, JP-A-2007-69448, JP-A-2005-67127, and JP-A-2005-280192. Herein, a sheet of printing paper is an example of the fluid ejection target medium, or, in other words, recording target medium. Each of the ink-jet printers disclosed in JP-A-2007-69448, JP-A-2005-67127, and JP-A-2005-280192 is a line-type ink-jet recording apparatus, which is hereafter referred to as a line printer or a line-head printer. There is more than one type in line printers. Some line printers have a plurality of recording heads that are arrayed along the direction of the width of a sheet of recording paper that is perpendicular to the transport direction thereof. Examples of such a configuration are disclosed in the above-identified unexamined Japanese patent application publications of JP-A-2007-69448 (specifically, refer to FIGS. 1 and 4 thereof) and JP-A-2005-67127 (specifically, refer to FIG. 1 thereof). Other line printers have an elongated recording head that extends to cover the entire width of a sheet of recording paper. An example of such a configuration is disclosed in the above-identified unexamined Japanese patent application publication of JP-A-2005-280192 (specifically, refer to Paragraph [0014] of Specification as well as FIGS. 2 and 3 thereof).

In a typical configuration of a line-head printer of the related art, a recording head(s) is provided as an immovable part/component. For this reason, although it is possible to use all nozzles for printing at the time when the printing is performed on a sheet of printing paper having a size equal to the maximum printable size, it is not possible to use all nozzles for printing at the time when the printing is performed on a sheet of printing paper having a size smaller than the maximum one. Specifically, no ink is ejected from nozzles that are arrayed at positions outside the maximum printable area (i.e., maximum printable range), which is dependent on (i.e., determined by) the width of the sheet of printing paper if it has a narrower width than the maximum printable width. This could cause the thickening of ink in such outer nozzles. The thickened ink could further cause the clogging of these nozzles. In order to provide a solution to such a problem, printers perform so-called flushing operation at predetermined time intervals during the execution of printing. For example, a printer performs the flushing operation at ten-second intervals. In the flushing operation, a printer ejects ink drops in a forcible manner, that is, not for the purpose of printing or independently thereof. By this means, the printer discharges any thickened ink out of the nozzles for renewing the state thereof. The flushing makes it possible to prevent the clogging, or other related problems, of some nozzles that are rarely used (or not used at all) for printing or some nozzles that are used for printing less frequently than others.

Despite the fact that the flushing provides an effective solution to the clogging of nozzles to some extent, the thickness of ink retained in a recording head never remains at a constant level. The same holds true for the thickness of ink remaining in nozzles. For example, during a time period of the traveling of ink inside a resin-made ink tube through which ink is supplied from an ink cartridge to a recording head, the moisture (i.e., a solvent or a dispersion medium) of the ink evaporates through the resin into air. As a result of the evaporation of the moisture thereof, the thickness of ink increases. Therefore, depending on the length of the retention time of ink inside the ink tube, or, in other words, depending on how long ink remains inside the ink tube, the thickness level of ink retained in a recording head could differ from one to another. In like manner, the thickness level of ink remaining in nozzles could vary from one to another depending on air temperature, air humidity, or other factors. Therefore, the actual thickness level of ink inside nozzles could be very high depending on the above-described conditions. In such a case, ink-discharge performance will be poor even if the flushing operation is performed at regular intervals. It is conceivable to shorten the cycle of flushing operation in order to overcome such a problem. However, if such a solution approach is employed/used, it will inevitably increase the consumption amount of ink that is wasted without being used for printing. In order to offer high printing cost performance, there is a limit in shortening the cycle of flushing operation.

### SUMMARY

An advantage of some aspects of the invention is to provide a fluid ejecting apparatus that can provide enhanced fluid ejection opportunity to a greater number of nozzles of a fluid ejecting head so as to prevent, or at least reduce, the clogging of the nozzles or other-related malfunctions. In addition, the invention further provides, as an advantage of some aspects thereof, a fluid ejection control method that is used by such a fluid ejecting apparatus.

In order to address the above-identified problem without any limitation thereto, the invention provides, as a first aspect thereof, a fluid ejecting apparatus that includes: an apparatus body; and a plurality of fluid ejecting heads that can eject fluid onto a fluid ejection target medium; wherein at least one of the plurality of fluid ejecting heads can move in a predetermined direction that intersects the transport direction of the fluid ejection target medium so as to change the relative positions of the plurality of fluid ejecting heads as viewed in the predetermined direction that intersects the transport direction of the fluid ejection target medium.

In the configuration of a fluid ejecting apparatus according to the first aspect of the invention described above, at least one of the plurality of fluid ejecting heads is moved in a predetermined direction that intersects the transport direction of the fluid ejection target medium so as to change the relative positions of the plurality of fluid ejecting heads as viewed in the predetermined direction that intersects the transport direction of the fluid ejection target medium. By this means, it is possible to set, for example, all nozzles at positions corresponding to the maximum fluid ejectable range that is in accordance with the size of the fluid ejection target medium. Therefore, it is possible to increase the number of nozzles that are actually used for ejecting fluid onto the fluid ejection target medium in fluid ejection processing (e.g., print processing). Accordingly, it is further possible to decrease the adverse possibility of the clogging of nozzles, the shortage of ink ejection amount, and/or other related problems that are caused as a result of poor fluid exchange inside the nozzles due to scarce ink ejection opportunity.

It is preferable that the fluid ejecting apparatus according to the first aspect of the invention described above should further include: a movable guiding section that can move so as to determine the position of the fluid ejection target medium as viewed in the predetermined direction that intersects the transport direction of the fluid ejection target medium; wherein the above-mentioned at least one of the plurality of fluid ejecting heads that can move in the predetermined direction that intersects the transport direction of the fluid ejection target medium moves together with the movable guiding section.

With such a preferred configuration of the fluid ejecting apparatus according to the first aspect of the invention, the above-mentioned at least one of the plurality of fluid ejecting heads moves together with the movable guiding section in the predetermined direction that intersects the transport direction of the fluid ejection target medium upon the movement, by a user, of the movable guiding section so as to determine the position of the fluid ejection target medium as viewed in the predetermined direction that intersects the transport direction of the fluid ejection target medium. By this means, it is possible to move the above-mentioned at least one movable fluid ejecting head to a position that is in accordance with the size of the fluid ejection target medium. For example, it is possible to set all nozzles at positions where the fluid ejection heads can eject fluid in the maximum fluid ejectable range that is in accordance with the size of the fluid ejection target medium.

In the preferred configuration of the fluid ejecting apparatus according to the first aspect of the invention described above, it is further preferable that one edge of the fluid ejection target medium as viewed in the direction of the width of the fluid ejection target medium should be taken as a guide basis; and the movable guiding section should be able to move in such a manner that the movable guiding section guides the other opposite edge of the fluid ejection target medium as viewed in the width direction of the fluid ejection target medium.

With such a preferred configuration of the fluid ejecting apparatus according to the first aspect of the invention, it is possible to fix the base-side (one edge of the fluid ejection target medium as viewed in the direction of the width of the fluid ejection target medium) one of the plurality of fluid ejecting heads. Therefore, it is possible to decrease the number of fluid ejecting heads that is necessary to move together with a target-position-determining section that includes but not limited to the movable guiding section. Therefore, it is possible to achieve a simple configuration with a smaller number of movable components.

It is preferable that the fluid ejecting apparatus according to the first aspect of the invention described above should further include: a plurality of caps that are used for capping the plurality of fluid ejecting heads, respectively, wherein the cap that corresponds to, or the caps that correspond to, the above-mentioned at least one of the plurality of fluid ejecting heads that can move in the predetermined direction that intersects the transport direction of the fluid ejection target medium can move together with the above-mentioned at least one of the plurality of fluid ejecting heads.

In the preferred configuration of the fluid ejecting apparatus according to the first aspect of the invention described above, the cap that corresponds to, or the caps that correspond to, the above-mentioned at least one of the plurality of fluid ejecting heads that can move in the predetermined direction that intersects the transport direction of the fluid ejection target medium move(s) together with the above-mentioned at least one of the plurality of fluid ejecting heads. Therefore, it is possible for each of the above-mentioned at least one of the plurality of fluid ejecting heads to immediately discharge fluid into the corresponding cap at its movement destination position without any further extra movement therefrom. Therefore, it is possible to avoid any ineffective extra movement of the fluid ejecting head so as to allow the fluid ejecting head to discharge fluid into the corresponding cap.

It is preferable that the fluid ejecting apparatus according to the first aspect of the invention described above should further include: a detecting section that can detect the position of the above-mentioned at least one movable fluid ejecting head as viewed in the predetermined direction that intersects the transport direction of the fluid ejection target medium; and a controlling section that identifies an overlapping area at which the plurality of fluid ejecting heads overlap each other or one another as viewed in the transport direction of the fluid ejection target medium in a fluid ejectable range on the basis of the detection result of the detecting section and then controls the plurality of fluid ejecting heads in such a manner that overlapping two or more fluid ejecting heads eject fluid in the identified overlapping area while shifting fluid landing positions on the fluid ejection target medium therebetween or thereamong. In the preceding sentence, the meaning of the phrase “shifting fluid landing positions on the fluid ejection target medium therebetween or thereamong” includes both of the following: firstly, fluid landing positions are shifted on a single fluid ejection target medium; secondly, fluid ejection target media onto which fluid lands are switched over.

In the preferred configuration of the fluid ejecting apparatus according to the first aspect of the invention described above, a detecting section detects the position of the above-mentioned at least one movable fluid ejecting head as viewed in the predetermined direction that intersects the transport direction of the fluid ejection target medium. In addition, a controlling section identifies an overlapping area at which the plurality of fluid ejecting heads overlap each other or one another as viewed in the transport direction of the fluid ejection target medium in a fluid ejectable range on the basis of the detection result of the detecting section. Then, the controlling section controls the plurality of fluid ejecting heads in such a manner that overlapping two or more fluid ejecting heads eject fluid in the identified overlapping area while shifting fluid landing positions on the fluid ejection target medium therebetween or thereamong. Therefore, the number of nozzles that are not actually used for fluid ejection decreases in the overlapping area at which the plurality of fluid ejecting heads overlap each other or one another as viewed in the transport direction of the fluid ejection target medium. By this means, it is possible to effectively prevent or reduce the clogging of nozzles or any other related problems.

In the preferred configuration of the fluid ejecting apparatus according to the first aspect of the invention described above, it is further preferable that the controlling section should switch over fluid ejecting heads for ejection of fluid at the identified overlapping area at each time when the fluid ejection target media are changed over.

If the preferred configuration described above is adopted, the controlling section switches over fluid ejecting heads for ejection of fluid at the identified overlapping area at each time when the fluid ejection target media are changed over. Since fluid ejecting heads are switched over on a target-by-target basis, it is possible to simplify fluid ejection control.

It is further preferable that the fluid ejecting apparatus having the preferred configuration described above should further include a driving section that moves the above-mentioned at least one movable fluid ejecting head in the predetermined direction that intersects the transport direction of the fluid ejection target medium, wherein the detecting section can detect the movement position of the movable guiding section; and the controlling section controls the driving operation of the driving section on the basis of the detection result of the detecting section so as to move the above-mentioned at least one movable fluid ejecting head to a position that is in accordance with the width of the fluid ejection target medium.

In the preferred configuration of the fluid ejecting apparatus described above, the detecting section detects the movement position of the movable guiding section that is manipulated (e.g., slid) by a user in accordance with the size (i.e., width) of the fluid ejection target medium. Then, the controlling section controls the driving operation of the driving section on the basis of the detection result of the detecting section so as to move the above-mentioned at least one movable fluid ejecting head to a position that is in accordance with the movement position of the movable guiding section. As described above, the above-mentioned at least one movable fluid ejecting head moves as driven by the driving section. Accordingly, the preferred configuration described above has an advantage in that a user can slide the movable guiding section with a smaller force and thus easily. In addition, the preferred configuration described above has another advantage in that, even when the user inadvertently touches the movable guiding section during the execution of fluid ejection, it is possible to avoid the fluid-ejection position of the fluid ejecting head from being displaced as a result of the unintended movement of the fluid ejecting head together with the inadvertent movement of the movable guiding section.

In order to address the above-identified problem without any limitation thereto, the invention provides, as a second aspect thereof, a fluid ejection control method that is used by a fluid ejecting apparatus, the fluid ejecting apparatus having a plurality of fluid ejecting heads that can eject fluid onto a fluid ejection target medium, at least one of the plurality of fluid ejecting heads being able to move in a predetermined direction that intersects the transport direction of the fluid ejection target medium so as to change the relative positions of the plurality of fluid ejecting heads as viewed in the predetermined direction that intersects the transport direction of the fluid ejection target medium, the fluid ejection control method including: moving the above-mentioned at least one movable fluid ejecting head to a position so as to position all nozzles inside the maximum fluid ejectable range that is determined by the size of the fluid ejection target medium; and controlling, if there is an overlapping area at which the fluid ejectable ranges of the plurality of fluid ejecting heads overlap each other or one another as viewed in the transport direction of the fluid ejection target medium, the plurality of fluid ejecting heads in such a manner that overlapping two or more fluid ejecting heads eject fluid in the overlapping area while shifting fluid landing positions on the fluid ejection target medium therebetween or thereamong.

The fluid ejection control method according to the second aspect of the invention described above offers the same advantageous effects as those offered by the fluid ejecting apparatus according to the first aspect of the invention described above.

### BRIEF DESCRIPTION OF THE DRAWINGS

The invention will be described with reference to the accompanying drawings, wherein like numbers reference like elements.

FIGS. 1A and 1B are a set of diagrams that schematically illustrates an example of the configuration of an ink-jet recording apparatus such as a printer, which is a non-limiting example of a fluid ejecting apparatus according to an exemplary embodiment of the invention, where FIG. 1A is a sectional view that schematically illustrates an example of the configuration of the ink-jet recording apparatus as viewed from an upstream side along the direction of paper transport, whereas FIG. 1B is a partial plan view that schematically illustrates an example of the configuration of a platen portion of the ink-jet recording apparatus.

FIG. 2 is a perspective view that schematically illustrates an example of the configuration of an ink-jet recording apparatus such as a printer according to an exemplary embodiment of the invention as viewed from above the ink-jet recording apparatus.

FIG. 3 is a perspective view that schematically illustrates an example of the configuration of an ink-jet recording apparatus such as a printer according to an exemplary embodiment of the invention as viewed from below the ink-jet recording apparatus.

FIG. 4 is a plan view that schematically illustrates an example of the configuration of an ink-jet recording apparatus such as a printer according to an exemplary embodiment of the invention, where a sheet of printing paper(s) having the maximum sheet size is set thereon.

FIG. 5 is a rear view that schematically illustrates an example of the configuration of an ink-jet recording apparatus such as a printer according to an exemplary embodiment of the invention.

FIG. 6 is a plan view that schematically illustrates an example of the configuration of an ink-jet recording apparatus such as a printer according to an exemplary embodiment of the invention, where a sheet of printing paper(s) having a sheet size that is smaller than the maximum sheet size is set thereon.

FIG. 7 is a partial side view that schematically illustrates an example of the configuration of an ink-jet recording apparatus such as a printer according to an exemplary embodiment of the invention.

FIG. 8 is a perspective view that schematically illustrates an example of the configuration of a first-line line head, which is a movable part/component, and a first-line maintenance apparatus according to an exemplary embodiment of the invention.

FIGS. 9A, 9B, and 9C are a set of bottom views that schematically illustrates an example of the relative positions of the first-line line head and a second-line line head as viewed from the nozzle-surface side thereof according to an exemplary embodiment of the invention.

FIG. 10 is a flowchart that schematically illustrates an example of a print processing routine according to an exemplary embodiment of the invention.

FIG. 11 is a block diagram that schematically illustrates an example of the electric configuration of an ink-jet recording apparatus such as a printer according to an exemplary embodiment of the invention.

FIG. 12 is a block diagram that schematically illustrates an example of the modified electric configuration of an ink-jet recording apparatus such as a printer according to a first variation example of the invention.

FIG. 13 is a plan view that schematically illustrates an example of the configuration of an ink-jet recording apparatus such as a printer according to a second variation example of the invention.

### DESCRIPTION OF EXEMPLARY EMBODIMENTS

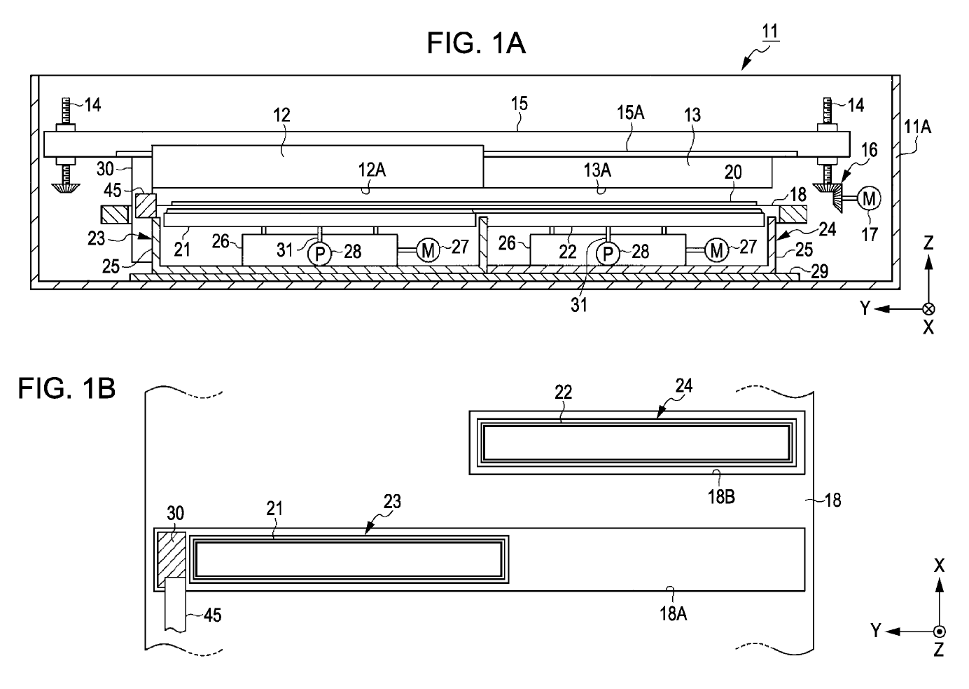

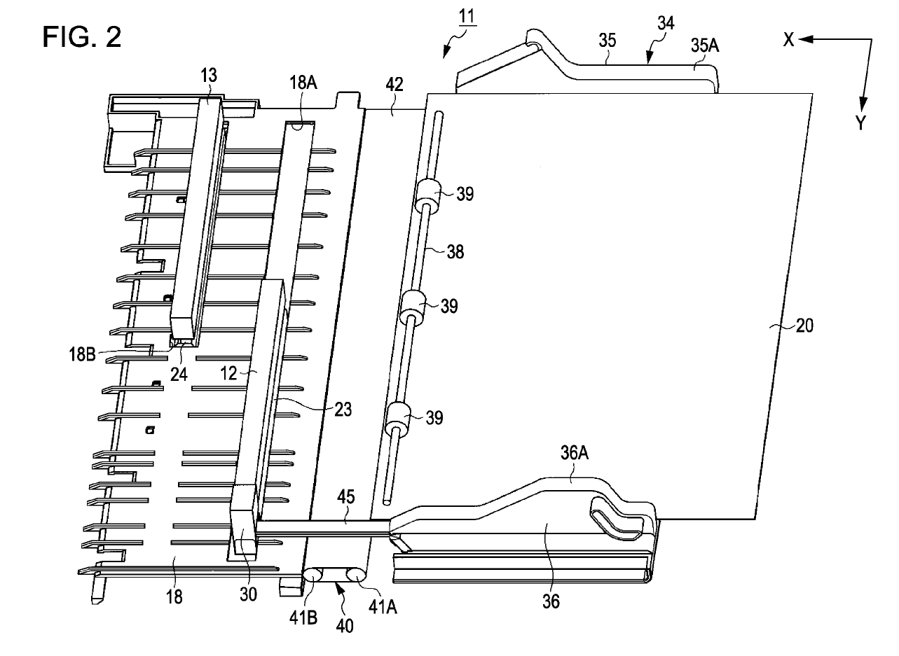

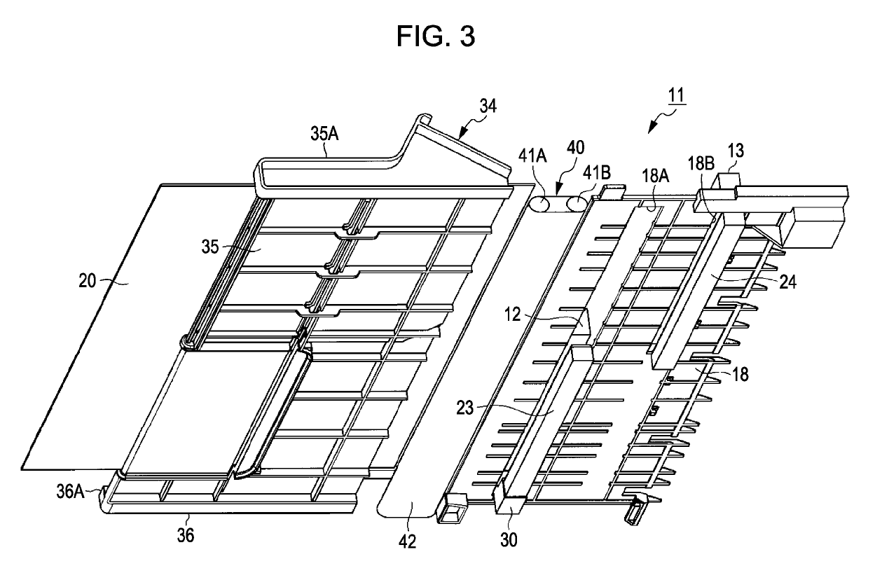

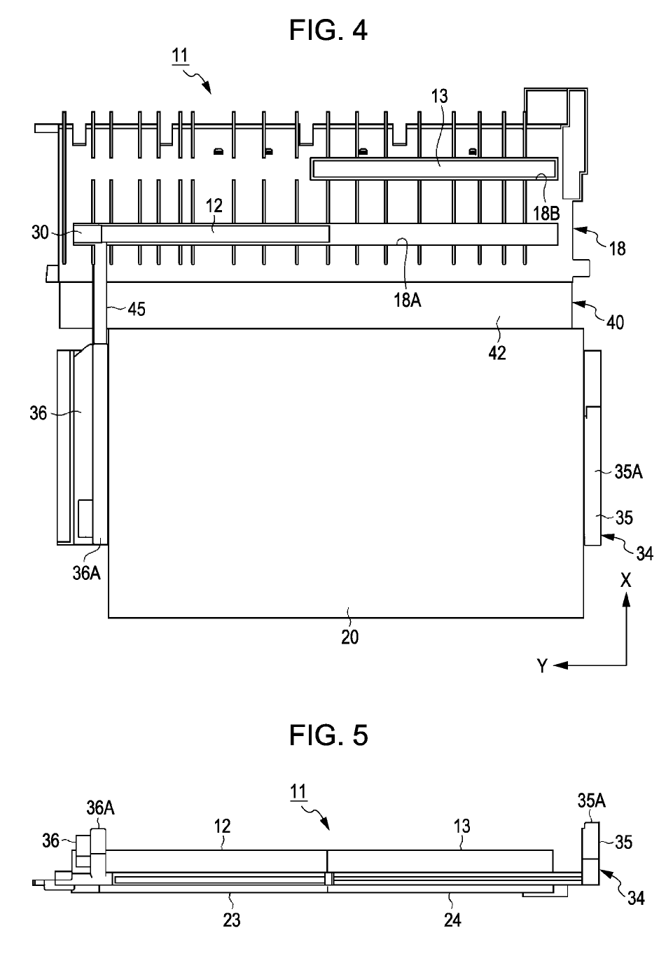

With reference to FIGS. 1-11, an exemplary embodiment of the invention is explained below. FIGS. 1A and 1B are a set of diagrams that schematically illustrates an example of the configuration of an ink-jet recording apparatus, which is a non-limiting example of a fluid ejecting apparatus according to an exemplary embodiment of the invention. Specifically, FIG. 1A is a sectional view that schematically illustrates an example of the configuration of the ink-jet recording apparatus as viewed from an upstream side along the direction of paper transport. FIG. 1B is a partial plan view that schematically illustrates an example of the partial configuration of the ink-jet recording apparatus under a pair of recording heads thereof. FIG. 2 is a perspective view that schematically illustrates an example of the configuration of an ink-jet recording apparatus according to an exemplary embodiment of the invention as viewed from above the ink-jet recording apparatus. FIG. 3 is a perspective view that schematically illustrates an example of the configuration of an ink-jet recording apparatus according to an exemplary embodiment of the invention as viewed from below the ink-jet recording apparatus. FIG. 4 is a plan view that schematically illustrates an example of the configuration of an ink-jet recording apparatus according to an exemplary embodiment of the invention. FIG. 5 is a rear view that schematically illustrates an example of the configuration of an ink-jet recording apparatus according to an exemplary embodiment of the invention.

An ink-jet recording apparatus according to the present embodiment of the invention, which is hereafter referred to as a printer 11, is configured as a line printer that is provided with a plurality of line heads. Specifically, as shown in FIG. 1A and FIG. 2, the printer 11 has a pair of line heads 12 and 13. The printable area offered by the plurality of line heads (pair of line heads 12 and 13 in the illustrated example) extends across the entire width of a sheet of printing paper having the maximum size. It should be noted that the pair of line heads 12 and 13 constitutes recording heads of the printer 11. As shown in FIG. 1, the printer 11 has a printer body case 11A that has the shape of an open-topped box. Four driving shafts 14 are provided inside the open-topped printer body case 11A. A supporting frame that is not shown in the drawing supports each of these four driving shafts 14 in such a manner that it (i.e., driving shaft 14) stands, or, in other words, is oriented in a vertical direction. It should be noted that only two of these four driving shafts 14 are illustrated in FIG. 1. In addition, it should be further noted that the number of the driving shafts 14 is not limited to four. Each of these four driving shafts 14 is formed as a screw shaft. Each of these four driving shafts 14 is screw-fixed in/through the corresponding one of four screw holes of a slide rail 15. Or, in other words, each of these four driving shafts 14 is threadably mounted through the slide rail 15. These four screw holes are formed at both ends of the slide rail 15 as viewed along the long-side direction thereof. In FIG. 1, the slide rail 15 is elongated in the horizontal direction. Accordingly, these four driving shafts 14 support the slide rail 15.

Each of the pair of line heads 12 and 13 hangs from the slide rail 15. These line heads 12 and 13 are arrayed not in alignment with each other. Specifically, the hanging positions of these two line heads 12 and 13 are shifted from each other so as to form an upstream line and a downstream line as viewed in the direction of paper transport, which is the X direction in FIG. 1. The line head 12, which constitutes a first line, is in engagement with a rail portion 15A that is formed as a part of the slide rail 15. Because of such a structure, the first-line line head 12 can move in a sliding manner along the direction of the width of a sheet of printing paper, which is orthogonal to the direction of paper transport. Hereafter, the direction of paper transport is referred to as “paper-transport X direction”, whereas the direction of the width of a sheet of printing paper perpendicular to the paper-transport X direction is referred to as “paper-width Y direction”. On the other hand, the line head 13, which constitutes a second line, is fixed on (i.e., under) the slide rail 15 at a predetermined position close to the right end of FIG. 1. It should be noted that the slide rail 15 is not illustrated in FIG. 2.

The aforementioned four driving shafts 14 shown in FIG. 1 are interlocked with one another by means of a power transmission mechanism, which is not shown in the drawing. With such a structure, these four driving shafts 14 can rotate in synchronization with one another. One of these four driving shafts 14 is in engagement with a gear mechanism 16. An electric motor 17 is connected to the gear mechanism 16. The electric motor 17 supplies motive power to the driving shaft 14 via the gear mechanism 16. In the illustrated example, the right driving shaft 14 is in engagement with the gear mechanism 16. As the electric motor 17 rotates in a normal/reverse direction, the line heads 12 and 13 move up/down in the Z direction illustrated in FIG. 1. By this means, it is possible to adjust a platen gap, which is a clearance between these line heads 12, 13 and a platen 18. The platen 18 is provided under the line heads 12 and 13. A sheet of printing paper 20, which is a recording target medium, is transported over the platen 18. The pair of line heads 12 and 13 discharges ink drops onto the sheet of printing paper 20. In this way, the printer 11 performs printing thereon.

As illustrated in FIG. 1 and FIG. 3, a maintenance apparatus 23 is provided under the first-line line head 12 in such a manner that the maintenance apparatus 23 and the line head 12 face each other. The maintenance apparatus 23 is provided with a cap 21. The cap 21 of the maintenance apparatus 23 is used to “cap” (i.e., seal) the nozzle surface 12A of the line head 12. On the other hand, a maintenance apparatus 24 is provided under the second-line line head 13 in such a manner that the maintenance apparatus 24 and the line head 13 face each other. The maintenance apparatus 24 is provided with a cap 22. The cap 22 of the maintenance apparatus 24 is used to cap the nozzle surface 13A of the line head 13. The platen 18 has openings 18A and 18B formed therein. The caps 21 and 22 face the line heads 12 and 13 with the openings 18A and 18B being interposed therebetween, respectively. Each of these caps 21 and 22 is configured in such a manner that it can be elevated (i.e., moved up/down) between a capping position and a retraction position. At the capping position, the cap 21 (22) is in contact with the nozzle surface 12A (13A) of the line head 12 (13). At the retraction position, the cap 21 (22) is distanced from the nozzle surface 12A (13A) of the line head 12 (13).

As illustrated in FIG. 1, each of the maintenance apparatuses 23 and 24 has a housing 25. Each of the housings 25 thereof has an open top. An elevation mechanism 26 that moves up/down the cap 21, an electric motor 27 that supplies motive power to the elevation mechanism 26, and a suction pump 28 that supplies a suction force to the cap 21 are provided inside the housing 25 of the maintenance apparatus 23. In like manner, another elevation mechanism 26 that moves up/down the cap 22, another electric motor 27 that supplies motive power to the elevation mechanism 26, and another suction pump 28 that supplies a suction force to the cap 22 are provided inside the housing 25 of the maintenance apparatus 24.

As illustrated in FIG. 1B, each of the caps 21 and 22 has the shape of an elongated rectangle in a plan view. The length of the cap 21 corresponds to that of the line head 12. The length of the cap 22 corresponds to that of the line head 13. The cap 21 has an open area that is wide enough to cover all nozzle lines 12B formed on the nozzle surface 12A of the line head 12 at the time when the cap 21 is brought into contact with the nozzle surface 12A of the line head 12. In like manner, the cap 22 has an open area that is wide enough to cover all nozzle lines 13B formed on the nozzle surface 13A of the line head 13 at the time when the cap 22 is brought into contact with the nozzle surface 13A of the line head 13. The number of each of the nozzle lines 12B and 13B is the same as the number of ink colors. In the configuration of the printer 11 according to the present embodiment of the invention, it is assumed that the number of each of the nozzle lines 12B and 13B, that is, the number of ink colors, is four.

The cap 21 is provided on a first line in such a manner that cap 21 is exposed through the opening 18A of the platen 18 as illustrated in FIGS. 1 and 2. As shown therein, the opening 18A of the platen 18 is elongated in the paper-width Y direction. Herein, the above-mentioned first line is assumed to be the upstream-side line as viewed along the paper-transport X direction. A housing rail 29 is formed on the inner bottom surface of the printer body case 11A. The housing 25 of the maintenance apparatus 23 can slide on the housing rail 29 so as to move in the paper-width Y direction. As the housing 25 of the maintenance apparatus 23 slides in the paper-width Y direction, the cap 21 moves together therewith in the paper-width Y direction along the opening 18A of the platen 18. On the other hand, since the housing 25 of the maintenance apparatus 24 is fixed to the printer body case 11A, the downstream-side cap 22 is fixed immediately beneath the line head 13.

In the configuration of the printer 11 according to the present embodiment of the invention, the first-line line head 12, which is a movable part/component, and the first-line maintenance apparatus 23 are coupled to each other by means of a coupling member 30. The coupling member 30 is connected to one end of the movable first-line line head 12 and also to the corresponding one end of the maintenance apparatus 23. With such a structure, the line head 12 and the maintenance apparatus 23 can move together in the paper-width Y direction. Therefore, the caps 21 and 22 are always positioned under the line heads 12 and 13 in such a manner that the caps 21 and 22 always face the line heads 12 and 13, respectively. The elevation mechanism 26 is a kind of power transmission mechanism that transforms/converts the rotation force of the electric motor 27 to the elevation force of the cap 21 (22), that is, power for moving up/down the cap 21 (22). As an example of inner components thereof, the elevation mechanism 26 is provided with a cam mechanism such as a rotating cam or a cylindrical cam (i.e., drum cam), though not limited thereto. Needless to say, it is possible to adopt an alternative power source other than one described above, including but not limited to, a cylinder, a solenoid, or a piezoelectric actuator.

As illustrated in FIG. 1, one end of a drain tube 31 is connected to the bottom surface of the cap 21 (22). The other end thereof is connected to a port of the suction pump 28. A pump motor, which is not illustrated in the drawing, supplies driving power to the suction pump 28. As a result of the driving of the pump motor under capping condition in which the cap 21 (22) is in contact with the nozzle surface 12A (13A) of the line head 12 (13), the inner pressure of the cap 21 (22) becomes negative due to a suction force applied thereto through the drain tube 31. In this way, any ink that has become thickened in the nozzles that are formed in the nozzle surface 12A (13A) of the line head 12 (13) and/or any air bubble formed in ink retained therein is removed from the nozzle surface 12A (13A) of the line head 12 (13). This operation is called as cleaning.

As illustrated in FIG. 2, a paper guide 34 is provided at an upstream region as viewed from the platen 18 along the paper-transport X direction. The paper guide 34 is used for setting a sheet(s) of printing paper 20 for printing. It should be noted that the above-mentioned upstream region at which the paper guide 34 is provided is the right side of FIG. 2 and the lower side of FIG. 4. As illustrated in FIG. 2 and FIG. 5, the paper guide 34 has a guide support member 35 and a movable guide member 36. The guide support member 35 is configured as a plate member. The movable guide member 36 is provided in such a manner that it can move in a sliding manner in the paper-width Y direction toward or away from the guide support member 35. The guide support member 35 has a fixed (i.e., immovable) guide portion 35A at one end thereof (i.e., right end in FIG. 4). The fixed guide portion 35A of the guide support member 35 projects upward so that the guide support member 35 can guide one end (i.e., right end in FIG. 4) of a sheet of printing paper 20 as viewed in the width direction thereof. On the other hand, the movable guide member 36 has a movable guide portion 36A at one end thereof (i.e., left end in FIG. 4). The movable guide portion 36A of the movable guide member 36 also projects upward so that the movable guide member 36 can guide the other end (i.e., left end in FIG. 4) of the sheet of printing paper 20 as viewed in the width direction thereof. For example, as a result of the sliding movement, by a user, of the movable guide portion 36A of the movable guide member 36 toward or away from the fixed guide portion 35A of the guide support member 35 in the paper-width Y direction, the setting position of a sheet of printing paper 20 is adjusted on the basis of the position of the movable guide portion 36A of the movable guide member 36. In the following description of this specification, this is referred to as “one-side slide paper adjustment” (or, in other words, one-side “non-slide” paper adjustment).

As illustrated in FIG. 2 and FIG. 4, in the configuration of the printer 11 according to the present embodiment of the invention, the movable guide member 36 that constitutes a part of the paper guide 34 is indirectly connected to the line head 12 and the maintenance apparatus 23 provided on the upstream line (i.e., first line) via the coupling member 30. Because of such a configuration, at the time when a user places sheets of printing paper 20 on the paper guide 34 and then slides the movable guide portion 36A of the movable guide member 36 in accordance with the sheet size thereof, the first-line line head 12 and the first-line maintenance apparatus 23 slide in the paper-width Y direction together with the movable guide portion 36A of the movable guide member 36. That is, as the movable guide portion 36A of the movable guide member 36 moves in a sliding manner in the paper-width Y direction, the first-line line head 12 and the first-line maintenance apparatus 23 are correctly positioned in accordance with the size of the sheets of printing paper 20.

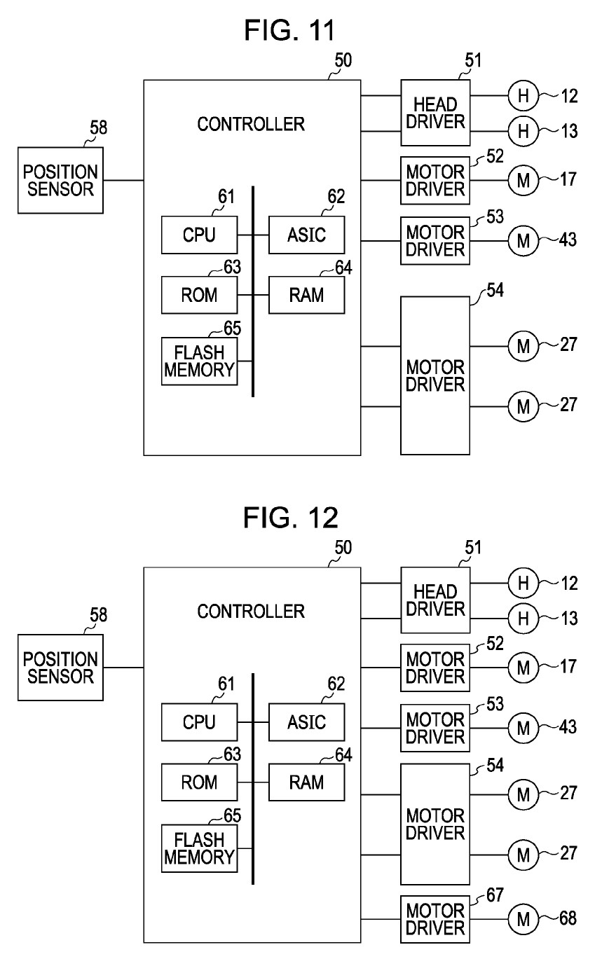

As illustrated in FIG. 2, a plurality of paper-feed rollers 39 and a paper-transport belt mechanism 40 are provided between the paper guide 34 and the platen 18. When viewed along the paper-transport X direction, the paper guide 34, the plurality of paper-feed rollers 39, the paper-transport belt mechanism 40, and the platen 18 are arranged in the order of appearance herein with the paper guide 34 being the most upstream one among them. The plurality of paper-feed rollers 39 is provided on a rotation axis 38. The paper-transport belt mechanism 40 transports, toward the line heads 12 and 13, a sheet of printing paper P that has been fed thereto from the plurality of paper-feed rollers 39. The paper guide 34 is provided with a hopper mechanism that is not illustrated in the drawing. The hopper becomes tilted at the time of paper-feed operation. As a result of the tilting operation of the hopper, the uppermost one of a plurality of sheets of printing paper 20 that are placed/stacked on the paper guide 34 is brought into contact with the plurality of paper-feed rollers 39. As the paper-feed rollers 39 rotate while being in contact with the uppermost sheet of printing paper 20, the uppermost sheet of printing paper 20 is picked up (i.e., drawn) for transport thereof. The paper-transport belt mechanism 40 has a pair of paper-transport rollers 41A and 41B. A paper-transport belt 42 is wound around the pair of paper-transport rollers 41A and 41B. An electric motor 43, which is illustrated in FIG. 11, supplies motive power to one of the above-mentioned pair of paper-transport rollers, the roller 41A. Driven by the electric motor 43, the paper-transport roller 41A rotates so as to function as a driving roller, whereas the other paper-transport roller 41B operates as a driven roller. The pair of paper-transport rollers 41A and 41B transports a sheet of printing paper 20 that has been fed from the paper-feed rollers 39 onto the paper-transport belt 42 in the paper-transport downstream direction. In the configuration of the printer 11 according to the present embodiment of the invention, an electrostatic-chuck belt operation scheme is used in the paper-transport belt mechanism 40, although the paper-transport belt mechanism 40 may adopt other alternative belt operation method. If the electrostatic-chuck belt operation scheme is employed, a sheet of printing paper 20 is transported/fed on the paper-transport belt 42 thereof while being electro-statically chucked to the paper-transport belt 42. It should be noted that a target-medium-transport means is not limited to the paper-transport belt mechanism 40 described above. As a non-limiting modification example thereof, a target-medium transport roller device that is made up of a target-medium transport driving roller and a target-medium transport driven roller may be adopted. In such a modified configuration, the target-medium transport roller device transports a target medium while the target medium is being pinched between the target-medium transport driving roller and the target-medium transport driven roller.

As illustrated in FIGS. 2, 4, and 7, a coupling rod 45 extends along the paper-transport X direction from the movable guide portion 36A of the movable guide member 36 to a position corresponding to an outer end of the line head 12 that is elongated in the paper-width Y direction. Or, in other words, the coupling rod 45 extends from the movable guide portion 36A of the movable guide member 36 to one end (the above-mentioned outer end) of the elongated line head 12 that is opposite to the other end thereof, where said other end of the elongated line head 12 is closer to the fixed guide portion 35A of the guide support member 35 than said one end thereof as viewed along the paper-width Y direction. The front end of the coupling rod 45 is fixed to the coupling member 30. With such a structure, as a user slides the movable guide portion 36A of the movable guide member 36 in the paper-width Y direction in accordance with the width size of a sheet of printing paper 20, the first-line line head 12 and the first-line maintenance apparatus 23 move together with the movable guide portion 36A of the movable guide member 36 in the paper-width Y direction.

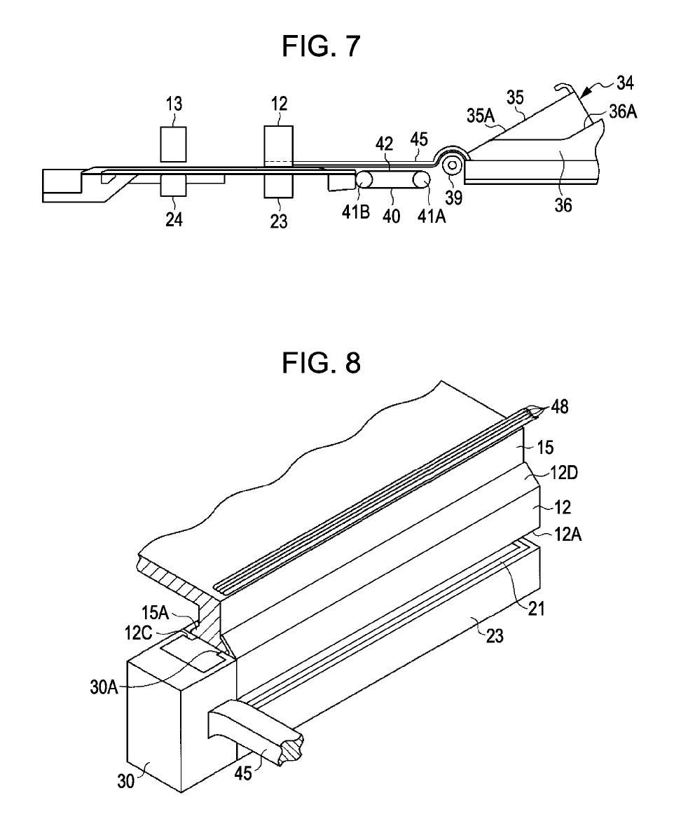

Since the coupling rod 45 extends in the paper-transport X direction from the movable guide portion 36A of the movable guide member 36, the coupling rod 45 is always positioned outside a sheet of printing paper 20 regardless of the sheet size thereof. Or, in other words, the coupling rod 45 is always positioned outside the above-mentioned outer end (i.e., one end) of the elongated line head 12 that is opposite to the above-mentioned other end thereof, where the above-mentioned other end of the elongated line head 12 is closer to the fixed guide portion 35A of the guide support member 35 than the above-mentioned one end thereof as viewed along the paper-width Y direction. For this reason, the coupling rod 45 never obstructs the transport of the sheet of printing paper 20. In addition, as illustrated in FIG. 7, the coupling rod 45 extends slightly over the paper-feed roller 39 in a circumventing or bypassing manner. Because of such a structure, the coupling rod 45 never obstructs the operation of any of the paper-feed rollers 39 regardless of the Y-directional paper-width position of the movable guide portion 36A of the movable guide member 36.

FIG. 8 is a perspective view that schematically illustrates an example of the configuration of the first-line line head 12, which is a movable part/component, and the first-line maintenance apparatus 23 according to the present embodiment of the invention. As illustrated in FIG. 8, the front end of the coupling rod 45 is connected to the coupling member 30. The lower part of the coupling member 30 is fixed to one side surface of the housing 25 of the maintenance apparatus 23. The upper part of the coupling member 30 is in engagement with (i.e., coupled with) one end portion of the line head 12. An engagement groove 12C is formed as a concavity in each of the front surface of the above-mentioned one end portion of the line head 12 and the rear surface thereof. Each of the pair of engagement grooves 12C extends in a vertical direction. On the other hand, a pair of engagement projections (i.e., projecting portions) 30A is formed at the upper part of the coupling member 30. Each of the pair of projecting portions 30A of the coupling member 30 fits in the corresponding one of the pair of engagement grooves 12C of the line head 12. Since each of the pair of projecting portions 30A of the coupling member 30 is in engagement with the corresponding one of the pair of engagement grooves 12C of the line head 12, the line head 12 is coupled to the coupling member 30 in such a manner that the line head 12 can slide in the vertical direction with respect to (i.e., as viewed from) the coupling member 30.

The upper part of the line head 12 is formed as a guide portion 12D that is formed so as to fit with the rail portion 15A of the slide rail 15. Since the guide portion 12D of the line head 12 is in engagement with the rail portion 15A of the slide rail 15, the line head 12 hangs from the slide rail 15 in such a manner that the line head 12 is allowed to move in the paper-width Y direction in a sliding manner thereunder. Having the above-described structure, the line head 12 can move in the paper-width Y direction together with the maintenance apparatus 23. In addition, because of the above-described structure, the line head 12 can move in the vertical Z direction with respect to (i.e., as viewed from) the platen 18 and the maintenance apparatus 23.

As illustrated in FIG. 8, a plurality of ink-supply tubes 48 is provided on the top of the slide rail 15. The plurality of ink-supply tubes 48 supplies ink to the line head 12 (13). In FIG. 8, the first-line ink-supply tubes 48 only are shown while the second-line ink-supply tubes 48 are omitted therefrom. The number of ink-supply tubes 48 is the same as the number of ink colors. In the illustrated example, four ink-supply tubes 48 are provided for the first-line line head 12. Four ink cartridges are detachably attached to a predetermined cartridge-attachment region inside the printer body case 11A of the printer 11. Each of these four ink cartridges contains ink that has the corresponding one of four ink colors, that is, cyan (C) magenta (M), yellow (Y), and black (K). Note that these four ink cartridges are not illustrated in the accompanying drawings. Ink of the corresponding color is supplied from each of these four ink cartridges through the ink-supply tube 48 to the line head 12 (13). Ink that has been supplied to each of the line heads 12 and 13 is ejected from nozzles thereof. A few examples of a method for supplying ink from these ink cartridges includes but not limited to a water-head-difference scheme, which is an ink-supply method that utilizes a water head difference, and a pressure-force scheme, which is an ink-supply method that utilizes a pressure force. A few examples of the above-described pressure-force scheme includes but not limited to a pressurized-air scheme (i.e., a pressure-force scheme that utilizes pressurized air), a magnetic-force scheme (i.e., a pressure-force scheme that utilizes a magnetic force), and an urging-force scheme (i.e., a pressure-force scheme that utilizes an urging force applied by an urging member such as a spring, though not limited thereto).

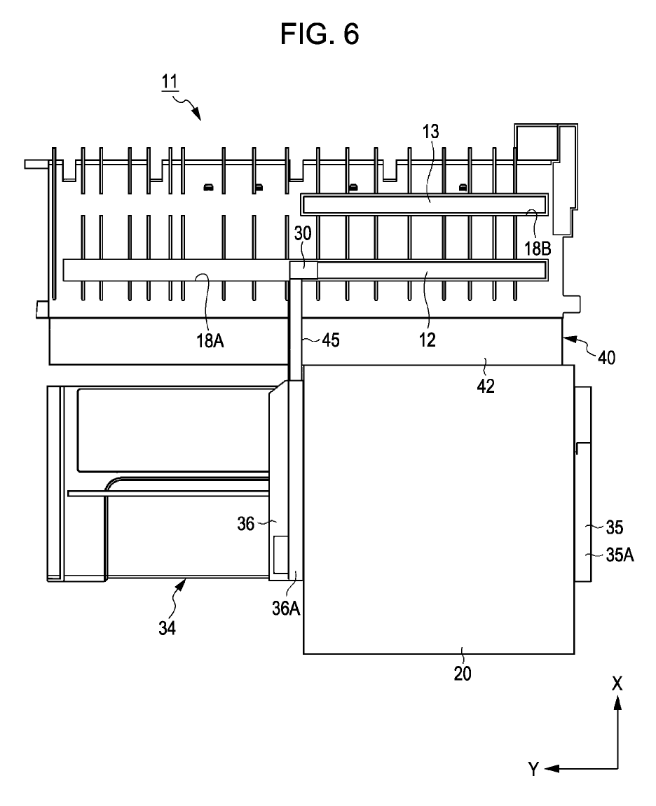

At the time when printing is performed on a sheet of printing paper 20 having the maximum sheet size (e.g., A3 paper size), as a result of the sliding operation of the movable guide portion 36A of the movable guide member 36 in the paper-width Y direction, the paper-width Y position of the line head 12 is shifted from the paper-width Y position of the line head 13 so that they scarcely overlap each other when viewed along the paper-transport X direction. A non-limiting example of such shifted and thus non-overlapping relative positions of the line heads 12 and 13 is illustrated in FIG. 4. On the other hand, at the time when printing is performed on a sheet of printing paper 20 having a half of the maximum sheet size (e.g., A4 paper size), as a result of the sliding operation of the movable guide portion 36A of the movable guide member 36 in the paper-width Y direction, the paper-width Y position of the line head 12 is completely “aligned” with the paper-width Y position of the line head 13 so that they almost entirely overlap each other when viewed along the paper-transport X direction. A non-limiting example of such aligned and thus overlapping relative positions of the line heads 12 and 13 is illustrated in FIG. 6. That is, as a user slides the movable guide portion 36A of the movable guide member 36 in the paper-width Y direction in accordance with the width size of a sheet of printing paper 20, the relative Y positions of the line heads 12 and 13 change in accordance with the width size of the sheet of printing paper 20.

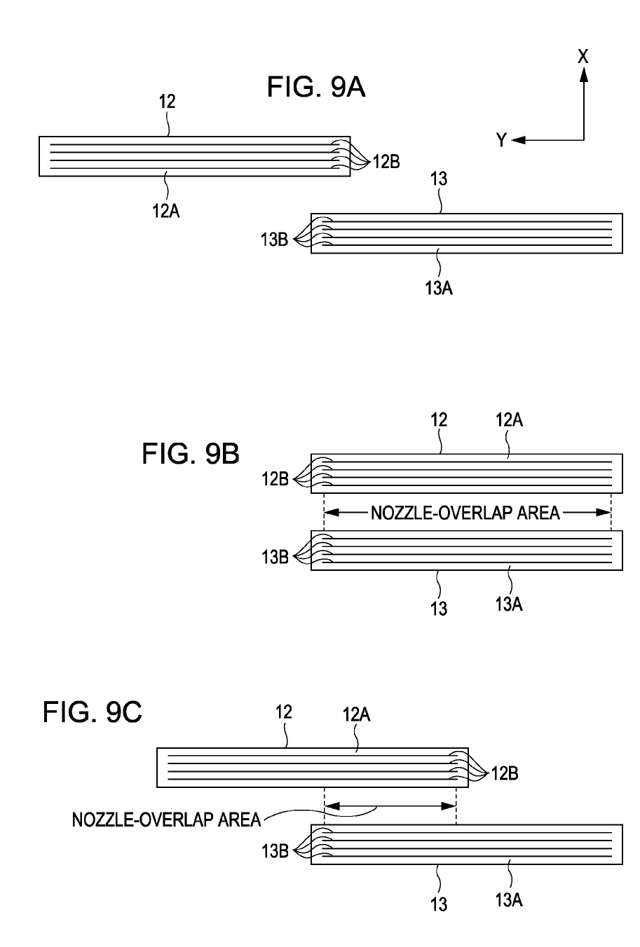

FIGS. 9A, 9B, and 9C are a set of bottom views that schematically illustrates an example of the relative positions of the line heads 12 and 13 as viewed from the nozzle-surface (12A, 13A) side thereof according to an exemplary embodiment of the invention. As has already been explained earlier, four nozzle lines 12B and 13B are formed on the nozzle surfaces 12A and 13A of the line heads 12 and 13, respectively. The nozzle surfaces 12A and 13A are the bottom surfaces of the line heads 12 and 13, respectively. Each of these four nozzle lines 12B and 13B corresponds to a set of four ink colors. Each of these four nozzle lines 12B and 13B extends the long-side direction of the elongated line head 12, 13. Or, in other words, each of these four nozzle lines 12B and 13B extends in the paper-width Y direction. Each one of four nozzle lines 12B is made up of a plurality of nozzles that are arrayed with staggered pitch. In the configuration of the printer 11 according to the present embodiment of the invention, each one of four nozzle lines 12B is made up of one hundred and eighty (180) nozzles. In like manner, each one of four nozzle lines 13B is made up of 180 nozzles that are arrayed with staggered pitch. All nozzles that belong to the same nozzle line 12B (13B) eject ink having the same color.

A built-in ejection drive element is provided for each nozzle of the line head 12 (13). These ejection drive elements are not shown in the drawing. As these ejection drive elements are driven, a force to eject ink is applied thereto. As a result thereof, the line head 12 (13) discharges ink drops from the nozzles thereof. As a few examples of a variety of eject-drive methods, a piezoelectric scheme, an electrostatic actuation scheme, or a thermal ejection scheme may be adopted, though not limited thereto. In the piezoelectric scheme, piezoelectric vibration elements are used as ejection drive elements. In the electrostatic actuation scheme, electrostatic actuators are used as ejection drive elements. In the thermal ejection scheme, a heater is used as ejection drive elements. An example of the thermal ejection scheme is a film-boiling method.

As the movable guide portion 36A of the movable guide member 36 that constitutes a part of the paper guide 34 moves in a sliding manner in the paper-width Y direction, the relative positions of the line heads 12 and 13 change. For example, as illustrated in FIGS. 9A, 9B, and 9C, there are three major set positions of the line heads 12 and 13, though not necessarily limited thereto. FIG. 9A illustrates an example of the positional relationship between the line heads 12 and 13 at the time when a sheet of printing paper 20 having the maximum sheet size (e.g., A3 paper size) is set on the paper guide 34. In the first example of the positional relationship between the line heads 12 and 13 shown in FIG. 9A, at least one nozzle of the line-end (e.g., right-end) portion of each of the nozzle lines 12B of the first-line line head 12, which is illustrated as the upper line head therein, overlaps the nozzle(s) of the line-end (e.g., left-end) portion of each of the nozzle lines 13B of the second-line line head 13, which is illustrated as the lower line head therein, when viewed along the paper-transport X direction, that is, the vertical direction of FIG. 9A. Or, alternatively, the right-end nozzle of each of the nozzle lines 12B of the first-line line head 12 is set at a position that is distanced, when viewed along the paper-transport X direction, from the left-end nozzle of each of the nozzle lines 13B of the second-line line head 13 with a clearance equal to a fixed nozzle pitch therebetween. With the above-described positional setting, it is possible for the line heads 12 and 13 to perform printing on the maximum printable area just by simply transporting a sheet of printing paper 20 in the paper-transport X direction without changing the relative positions thereof during the execution of printing.

FIG. 9B illustrates the second example of the positional relationship between the line heads 12 and 13. In FIG. 9B, it is assumed that a sheet of printing paper 20 having a width smaller than the maximum one, for example, a half of the maximum sheet size (i.e., A4 paper size), is set on the paper guide 34, followed by the positional adjustment/determination thereof by means of the movable guide portion 36A of the movable guide member 36. In this example, when viewed along the paper-transport X direction, the nozzle lines 12B of the first-line line head 12 completely (i.e., perfectly) overlap the nozzle lines 13B of the second-line line head 13, thereby forming the maximum (i.e., complete or perfect) nozzle-overlap area (i.e., overlapping-nozzle area). FIG. 9C illustrates the third example of the positional relationship between the line heads 12 and 13. In FIG. 9C, it is assumed that a sheet of printing paper 20 having a width smaller than the maximum sheet size (e.g., A3 paper size) but larger than a half of the maximum sheet size (i.e., A4 paper size) is set on the paper guide 34, followed by the positional adjustment/determination thereof by means of the movable guide portion 36A of the movable guide member 36. In this example, when viewed along the paper-transport X direction, the nozzle lines 12B of the first-line line head 12 partially overlap the nozzle lines 13B of the second-line line head 13, thereby forming a partial nozzle-overlap area.

As illustrated in FIG. 9A, on the condition that printing is performed on a sheet of printing paper 20 having the maximum sheet size, both of all nozzles of the nozzle lines 12B of the first-line line head 12 and all nozzles of the nozzle lines 13B of the second-line line head 13 are used for printing. It should be noted that, however, in an actual execution of a certain printing job, there could be some nozzles that do not discharge any ink drop at all during the execution thereof depending on the content of print data. On the other hand, in a case where printing is performed under the condition that each of the nozzle lines 12B of the first-line line head 12 completely overlaps the corresponding same-ink-color one of the nozzle lines 13B of the second-line line head 13 when viewed along the paper-transport X direction as illustrated in FIG. 9B, thereby forming the above-described complete nozzle-overlap area, active nozzles that are actually used for printing are switched over (at the nozzle-overlap area) between the overlapping (i.e., all) nozzles of each of the nozzle lines 12B of the first-line line head 12 and the overlapping (i.e., all) nozzles of the corresponding same-ink-color one of the nozzle lines 13B of the second-line line head 13. By this means, almost equal ink-ejection opportunity is given to these nozzles so as to achieve a desirable ink-discharge control. In like manner, in a case where printing is performed under the condition that each of the nozzle lines 12B of the first-line line head 12 partially overlaps the corresponding same-ink-color one of the nozzle lines 13B of the second-line line head 13 when viewed along the paper-transport X direction as illustrated in FIG. 9C, thereby forming the above-described partial nozzle-overlap area, active nozzles that are actually used for printing are switched over (at the nozzle-overlap area) between the overlapping (i.e., some) nozzles of each of the nozzle lines 12B of the first-line line head 12 and the overlapping (i.e., some) nozzles of the corresponding same-ink-color one of the nozzle lines 13B of the second-line line head 13. By this means, almost equal ink-ejection opportunity is given to these nozzles so as to achieve a desirable ink-discharge control.

In the configuration of the printer 11 according to the present embodiment of the invention, the maximum printable area, which is a non-limiting example of the “maximum fluid ejectable range” according to the invention, is determined with the addition of a predetermined outside run-over length at each of the left and right edges of a sheet of printing paper 20 having the maximum sheet size viewed along the paper-width Y direction. Because of the addition of the predetermined outside run-over length at each of the left and right edges thereof, the printer 11 according to the present embodiment of the invention can perform so-called borderless printing on a sheet of printing paper 20 having the maximum sheet size without leaving no paper margin thereon under the positional setting of the first-line line head 12 and the second-line line head 13 shown in FIG. 9A. The length of each of the nozzle lines 12B and the nozzle lines 13B is determined in such a manner that the nozzles of the first-line line head 12 and the nozzles of the second-line line head 13 can be positioned throughout the entire length of the maximum printable area in a uniform layout/array. The predetermined outside run-over length that is added at each of the left and right edges of a sheet of printing paper 20 having the maximum sheet size viewed along the paper-width Y direction is set at, for example, 1-10 mm. The maximum fluid ejectable range according to the invention is embodied in the configuration of the printer 11 according to the present embodiment of the invention as the maximum ink ejectable range that makes it possible to perform the above-described borderless printing, that is, printing without leaving any paper margin.

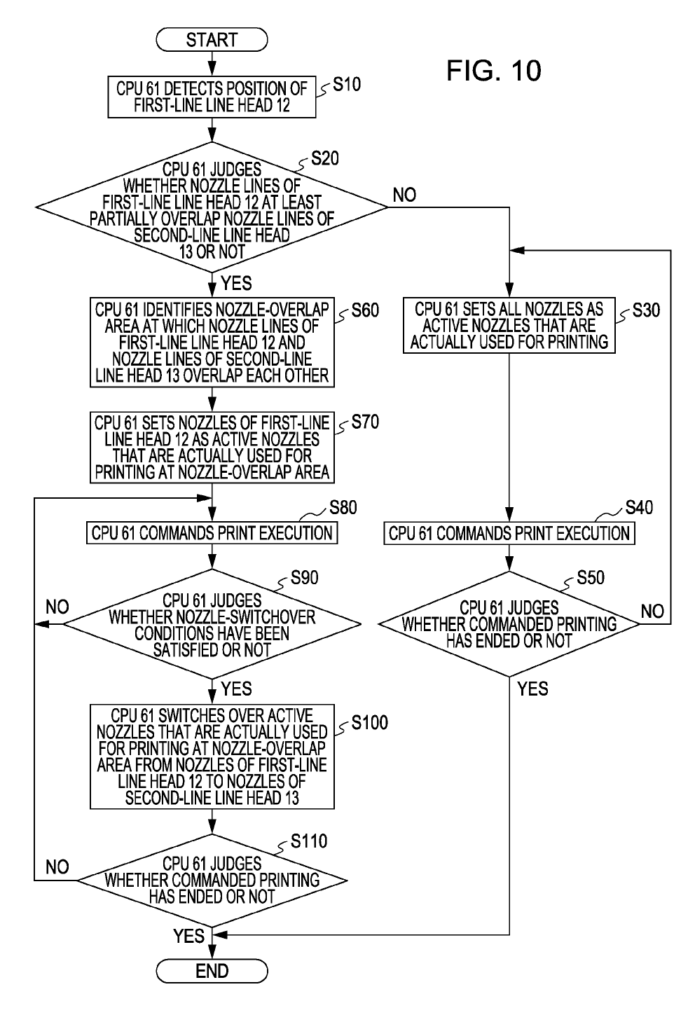

FIG. 11 is a block diagram that schematically illustrates an example of the electric configuration of the printer 11 according to an exemplary embodiment of the invention. As shown in FIG. 10, the printer 11 is provided with a controller 50, a head driver 51, and motor drivers 52, 53, and 54. The controller 50 is electrically connected to each of the line heads 12 and 13 via the head driver 51. The controller 50 is further electrically connected to the elevation electric motor 17 via the motor driver 52. The controller 50 is further electrically connected to the paper-feed and paper-transport electric motor 43 via the motor driver 53. The controller 50 is further electrically connected to each of the cap-elevation electric motors 27, 27 via the motor driver 54. A position sensor 58 is electrically connected to the controller 50. The position sensor 58 detects the position of the movable guide portion 36A of the movable guide member 36. As the position sensor 58 detects the position of the movable guide portion 36A of the movable guide member 36, it further detects the positions of the line head 12 and the maintenance apparatus 23 that move together with the movable guide portion 36A of the movable guide member 36.

The controller 50 has, as its inner components, a CPU 61, an ASIC (Application Specific IC) 62, a ROM 63, a RAM 64, and a flash memory 65. The ROM 63 stores various kinds of programs that can be executed by the CPU 61. The RAM 64 is used as a work memory into which the CPU 61 can temporarily store data such as the result of calculation, though not necessarily limited thereto. The flash memory 65 stores, though not necessarily limited thereto, reference data that is used for determining the specific control behavior of ink-discharging operation that is performed by each of the line heads 12 and 13. In the configuration of the printer 11 according to the present embodiment of the invention, the flash memory 65 stores table data as the reference data. The table data stored in the flash memory 65 shows a relationship between the detected position of the line head 12 and the nozzle-overlap area at which, or, in other words, overlapping amount by which, the nozzle lines 12B of the line head 12 and the nozzle lines 13B of the line head 13 overlap each other. With such a configuration, the CPU 61 refers to the table data so as to identify nozzles that are located inside the nozzle-overlap area (i.e., overlapping-nozzle area) at which the nozzle lines 12B of the line head 12 and the nozzle lines 13B of the line head 13 overlap each other on the basis of the position of the line head 12 detected by the position sensor 58. For example, the CPU 61 can identify the nozzle numbers of nozzles that are located inside the nozzle-overlap area at which the nozzle lines 12B of the line head 12 and the nozzle lines 13B of the line head 13 overlap each other.

A predetermined flushing execution time interval is set in advance. The flushing execution time interval is preset at, for example, 5-20 seconds. At each time when the flushing execution time elapses, which is measured by means of a timer that is not shown in the drawing, flushing operation is executed. Or, more specifically, after the elapsing of the flushing execution time, flushing operation is executed during a time period in which no sheet of printing paper 20 is present over the caps 21 and 22 after the ejection of the current sheet of printing paper 20 therefrom and before the incoming transport of the next sheet of printing paper 20 thereto. For example, flushing is performed at each time when the predetermined number of sheets of printing paper has been printed if the printing speed is high, whereas flushing is performed at each time when one sheet of printing paper has been printed if a high print resolution is required.

FIG. 10 is a flowchart that schematically illustrates an example of the program of ink-discharging control processing routine that is executed by the CPU 61 inside the controller 50 at the time when the printer 11 according to the present embodiment of the invention performs printing. In the following description, the ink-discharging control processing routine that is executed by the CPU 61 is explained while making reference to FIG. 10.

Prior to the start of printing, a user sets sheets of printing paper 20 on the paper guide 34 and then moves the movable guide portion 36A of the movable guide member 36 in accordance with the width size of the sheets of printing paper 20. As a result of the movement of the movable guide portion 36A of the movable guide member 36, the position of the line head 12, which moves together with the movable guide portion 36A of the movable guide member 36, is determined in accordance with the width size of the sheets of printing paper 20. For example, if the sheets of printing paper 20 have the maximum size, the relative positions (i.e., positional relationship) of the first-line line head 12 and the second-line line head 13 are set as illustrated in FIG. 4. On the other hand, if the sheets of printing paper 20 have a size equal to a half of the maximum size, the relative positions of the first-line line head 12 and the second-line line head 13 are set as illustrated in FIG. 6.

After having determined the set position of the line head 12, the user sets/specifies printing conditions by manipulating the input device of a host computer that is not illustrated in the drawing. Examples of the printing parameters that are set/specified by the user include but not limited to, a paper type, a paper size, a layout, color/monochrome, and quality (high-quality printing/draft printing). At the host computer, a printer driver performs resolution conversion processing so as to convert the resolution of image data into print resolution. Next, for example, RGB image data is converted into CMYK image data in accordance with printing conditions. Then, the host computer sends the processed data to the printer 11 as bitmap print data. Upon reception of the print data, the printer 11 starts printing.

Upon the start of printing, in the first step S10 of the ink-discharging control processing routine, the CPU 61 detects the position of the movable guide portion 36A of the movable guide member 36 as viewed along the paper-width Y direction on the basis of a position signal that is supplied from the position sensor 58. Or, in other words, in the first step S10 of the ink-discharging control processing routine, the CPU 61 detects the positions of the line head 12, which lies on the first line, and the maintenance apparatus 23 as viewed along the paper-width Y direction on the basis of the position signal that is supplied from the position sensor 58.

In the next step S20, the CPU 61 refers to table data that has been read out of the flash memory 65 so as to make a judgment as to whether there is any overlap between the nozzle lines 12B of the first-line line head 12 and the nozzle lines 13B of the second-line line head 13 on the basis of the position detected by the position sensor 58. That is, in this step S20, the CPU 61 makes a judgment as to whether the nozzle lines 12B of the first-line line head 12 overlap, at least partially, the nozzle lines 13B of the second-line line head 13 or not on the basis of the position detected by the position sensor 58 as viewed along the paper-transport X direction.

For example, at the time when a sheet of printing paper 20 having the maximum sheet size (e.g., A3 paper size) is printed, the movable guide portion 36A of the movable guide member 36 is set at the outermost position as illustrated in FIG. 4. In FIG. 4, the outermost set position of the movable guide portion 36A of the movable guide member 36 is the left-end position. If the movable guide portion 36A of the movable guide member 36 is set at the outermost position as illustrated in FIG. 4, the CPU 61 judges that there is no overlap, as shown in FIG. 9A, between the nozzle lines 12B of the first-line line head 12 and the nozzle lines 13B of the second-line line head 13 as viewed along the paper-transport X direction on the basis of the detected position of the line head 12. On the other hand, at the time when a sheet of printing paper 20 having a size smaller than the maximum sheet size is printed, the CPU 61 judges that the line head 12 is positioned relative to the line head 13 in such a manner that the nozzle lines 12B of the line head 12 at least partially overlap the nozzle lines 13B of the line head 13 as illustrated in FIG. 9B or FIG. 9C. If there is not any overlap between the nozzle lines 12B of the line head 12 and the nozzle lines 13B of the line head 13, the process moves onto the step S30. On the other hand, if there is at least partial overlap between the nozzle lines 12B of the line head 12 and the nozzle lines 13B of the line head 13, the process moves onto the step S60.

In the step S30, all nozzles are set as active nozzles that are actually used for printing because it was judged in the preceding step S20 that there is not any overlap between the nozzle lines 12B of the line head 12 and the nozzle lines 13B of the line head 13. Thereafter, printing is executed in the next step S40. In the print execution step of S40, there are greater opportunities/possibilities for the ejection of ink from all nozzles at least once during the execution of printing because all nozzles are set as active nozzles that are actually used for printing. After the printing of one sheet of printing paper 20 has completed, the CPU 61 makes a judgment as to whether the commanded printing job has ended or not (step S50). If the printing job has not ended yet (step S50: NO) because there is/are any sheet(s) of printing paper 20 waiting to be printed, the printer 11 ejects the current (i.e., printing-completed) sheet of printing paper 20 and feeds the next sheet of printing paper 20 for successive printing. The judgment step S50 is repeated at each time of the completion of the printing of one sheet of printing paper 20 until the CPU 61 judges that the printing job has ended (step S50: YES). If the positive judgment result is outputted in this judgment step S50, which means that the commanded printing job has been ended for all sheets of printing paper 20, the CPU 61 terminates the ink-discharging control processing routine described herein.

On the other hand, if the CPU 61 judged in the aforementioned step S20 that the nozzle lines 12B of the first-line line head 12 overlap, at least partially, the nozzle lines 13B of the second-line line head 13 as viewed along the paper-transport X direction on the basis of the positions of the first-line line head 12 and the maintenance apparatus 23, the CPU 61 identifies, in the step S60, the nozzle-overlap area at which the nozzle lines 12B of the line head 12 and the nozzle lines 13B of the line head 13 overlap each other by means of the result of positional detection made by the position sensor 58. In a case where the line head 12 is positioned relative to the line head 13 in such a manner that the nozzle lines 12B of the line head 12 at least partially overlap the nozzle lines 13B of the line head 13 as illustrated in FIG. 9B or FIG. 9C, the CPU 61 refers to the table data and then identifies, on the basis of the detected position supplied from the position sensor 58, the number of nozzles that are located inside the nozzle-overlap area at which the nozzle lines 12B of the line head 12 and the nozzle lines 13B of the line head 13 overlap each other among a plurality of nozzles that constitute the nozzle lines 12B and 13B thereof. For example, assuming that the total one hundred and eighty nozzles are numbered from #1 to #180, all nozzles (#1-#180) are identified as overlapping nozzles that are located in the nozzle-overlap area if the relative positions (i.e., positional relationship) of the nozzle lines 12B of the first-line line head 12 and the nozzle lines 13B of the second-line line head 13 are set as illustrated in FIG. 9B. On the other hand, if the relative positions of the nozzle lines 12B of the first-line line head 12 and the nozzle lines 13B of the second-line line head 13 are set as illustrated in FIG. 9C, and further if the number of nozzles that are identified as overlapping nozzles located in the overlap-nozzle area is 80, the CPU 61 identifies that the nozzles #101-#180 of the line head 12 and the nozzles #1-#80 of the line head 13 as the number of the overlapping nozzles that are located in the nozzle-overlap area.

In the step S70, the CPU 61 prioritizes the first-line line head 12 over the second-line line head 13 at the nozzle-overlap area at which the nozzle lines 12B of the line head 12 and the nozzle lines 13B of the line head 13 overlap each other and thus sets the nozzles of the first-line line head 12 as active nozzles that are actually used for printing at the above-described nozzle-overlap area (i.e., overlapping-nozzle area). For example, in the nozzle-number example described above, the nozzles #101-#180 of the first-line line head 12 are set as active nozzles that are actually used for printing at the above-described nozzle-overlap area. At the non-overlap area at which the nozzle lines 12B of the line head 12 and the nozzle lines 13B of the line head 13 do not overlap each other, the remaining nozzles that are located outside the above-described nozzle-overlap area are set as active nozzles that are actually used for printing. That is, the nozzles #1-#100 of the first-line line head 12 and the nozzles #81-#180 of the second-line line head 13 are set as active nozzles that are actually used for printing at the above-described non-overlap area. Then, in the step S80, printing is executed by means of nozzles having nozzle numbers that are set as the number of active nozzles that are actually used for printing.

In the step S90, the CPU 61 makes a judgment as to whether nozzle-switchover conditions have been satisfied or not. In the configuration of the printer 11 according to the present embodiment of the invention, the nozzle-switchover conditions are set as the changing of print-target sheets of paper 20 due to the ejection of the current sheet of print-completed paper 20 and the feeding of the next sheet of printing paper 20. Therefore, it is judged in the step S90 that the nozzle-switchover conditions are satisfied at the time when print-target sheets of paper 20 are changed due to the ejection of the current sheet of print-completed paper 20 and the feeding of the next sheet of printing paper 20. Then, the process moves on to the next step S100.

In the step S100, the CPU 61 switches over the active nozzles that are actually used for printing at the nozzle-overlap area at which the nozzle lines 12B of the first-line head 12 and the nozzle lines 13B of the second-line head 13 overlap each other from the nozzles of the first-line line head 12 to the nozzles of the second-line line head 13. In the foregoing example, the active nozzles that are actually used for printing at the nozzle-overlap area at which the nozzle lines 12B of the first-line head 12 and the nozzle lines 13B of the second-line head 13 overlap each other are switched over from the nozzles #101-#180 of the first-line line head 12 to the nozzles #1-#80 of the second-line line head 13. Then, a series of steps from S80 inclusive to S110 inclusive is repeated until printing is completed for all print-instructed sheets of printing paper. At each time when print-target sheets of paper 20 are changed due to the ejection of the current sheet of print-completed paper 20 and the feeding of the next sheet of printing paper 20, the active nozzles that are actually used for printing at the nozzle-overlap area at which the nozzle lines 12B of the first-line head 12 and the nozzle lines 13B of the second-line head 13 overlap each other are switched over, in alternate shifts, between the nozzles #101-#180 of the first-line line head 12 and the nozzles #1-#80 of the second-line line head 13.

In the illustrated example of FIG. 9C, the active nozzles that are actually used for printing at the nozzle-overlap area at which the nozzle lines 12B of the first-line head 12 and the nozzle lines 13B of the second-line head 13 overlap each other are switched over between the nozzles #101-#180 of the first-line line head 12 and the nozzles #1-#80 of the second-line line head 13 in an alternate manner. On the other hand, in the illustrated example of FIG. 9B, the active nozzles that are actually used for printing at the nozzle-overlap area at which the nozzle lines 12B of the first-line head 12 and the nozzle lines 13B of the second-line head 13 overlap each other are switched over between all nozzles #1-#180 of the first-line line head 12 and all nozzles #1-#180 of the second-line line head 13 in an alternate manner.

By this means, in a case where the nozzle lines 12B of the first-line line head 12 partially overlap the nozzle lines 13B of the second-line line head 13 when viewed along the paper-transport X direction, thereby forming a partial nozzle-overlap area as illustrated in FIG. 9C, printing is performed on the first sheet of printing paper 20 by means of the active nozzles of the first-line line head 12 at the nozzle-overlap area at which the nozzle lines 12B of the first-line head 12 and the nozzle lines 13B of the second-line head 13 overlap each other, whereas printing is performed on the second sheet of printing paper 20 by means of the active nozzles of the second-line line head 13 at the above-described nozzle-overlap area. In such a case, all of the remaining nozzles that are located outside the above-described nozzle-overlap area are set as active nozzles that are actually used for printing.

Control for switching over the active nozzles that are actually used for printing at the nozzle-overlap area at which the nozzle lines 12B of the first-line head 12 and the nozzle lines 13B of the second-line head 13 overlap each other is performed as follows. As a first step of active-nozzle switchover control, print data (bitmap data) is expanded on a memory such as the RAM 64, though not necessarily limited thereto. Then, the expanded data is read out in the readout unit of one raster line for the nozzle lines 12B, 13B at a time, or, in other words, the expanded data is read out for one raster line of the nozzle lines 12B, 13B at each single readout execution. While the expanded data is read out in such a way, a data portion that should be printed out by the nozzles of the first-line line head 12 is transferred to the first-line driver system of the head driver 51 that is dedicated for driving the first-line line head 12 whereas a data portion that should be printed out by the nozzles of the second-line line head 13 is transferred to the second-line driver system of the head driver 51 that is dedicated for driving the second-line line head 13. In the above-explained distribution (i.e., transfer) of the data portions of readout data, the data-transfer destination of a data portion that should be printed out by nozzles located in the nozzle-overlap area is determined on the basis of the initial conditions of the above-explained step S70 illustrated in FIG. 10 or the aforementioned nozzle-switchover conditions of the above-explained steps S90 and S100 illustrated therein. On the basis of the result of determination thereof, the data portion that should be printed out by nozzles located in the nozzle-overlap area is assigned (i.e., transferred) to either the first-line line head 12 or the second-line line head 13 in synchronization with ink-ejection timing that is determined on the basis of the relative positions of the first-line line head 12 and the second-line line head 13 with respect to a sheet of printing paper 20 that differ from one to another. The print execution step explained above is performed in the step S80 of the ink-discharging control processing routine according to the present embodiment of the invention.

The aforementioned flushing is carried out at each point in time at which no sheet of printing paper 20 is present between the first-line line head 12 and the cap 21 as well as between the second-line line head 13 and the cap 22 because of the ejection of a print-completed sheet of printing paper 20 after the elapsing of the aforementioned flushing execution time (i.e., preset flushing execution interval/flushing set time) during the execution of printing. In the flushing, all nozzles of the first-line line head 12 and the second-line line head 13 discharge ink drops toward the caps 21 and 22, respectively.

In the configuration of the printer 11 according to the present embodiment of the invention, the movable first-line line head 12 moves together with the movement of the movable guide portion 36A of the movable guide member 36. Because of such a structure, all nozzles of the movable first-line line head 12 are positioned inside the maximum printable area that is determined on the basis of the size of a sheet of printing paper 20. Therefore, all nozzles are used as the aforementioned active nozzles at the time when, for example, borderless printing is performed. In comparison with the configuration of a fixed/immovable line head of the related art, the movable line-head configuration of the printer 11 according to the present embodiment of the invention makes it possible to increase the ink-ejection opportunities for all nozzles during printing. Although a small number of nozzles that are provided in the predetermined outside run-over area are not used as the aforementioned active nozzles in borderless printing, almost all of nozzles except for the outside run-over nozzles are always used as the active nozzles regardless of the sheet size of printing paper. As understood from the foregoing explanation of the movable line-head configuration of the printer 11 according to the present embodiment of the invention, it is possible to make the number of nozzles from which ink drops are ejected for printing larger in comparison with that of a fixed/immovable line head of the related art. As the number of nozzles from which ink drops are ejected for printing increases, the number of nozzles from which ink drops are ejected only for flushing decreases. As a result thereof, the movable line-head configuration of the printer 11 according to the present embodiment of the invention makes it possible to effectively prevent or reduce the clogging of nozzles.

As explained in detail above, the printer 11 according to the present embodiment of the invention offers the following advantageous effects of the invention.

(1) Since the relative positions of the movable first-line line head 12 and the second-line line head 13 as viewed along the paper-width Y direction can be changed, it is possible to position all nozzles inside the maximum printable area that is determined on the basis of the size of a sheet of printing paper 20. By this means, it is possible to give ink-ejection opportunity to a larger number of nozzles. As a result thereof, it is possible to effectively prevent the thickening of ink inside nozzles and thus further prevent the clogging of the nozzles. For example, as has already been explained above, during a time period of the traveling of ink inside a resin-made ink tube through which ink is supplied from an ink cartridge to a recording head, the moisture of the ink evaporates through the resin into air. As a result of the evaporation of the moisture thereof, the thickness of ink increases. Therefore, depending on the length of the retention time of ink inside the ink tube, or, in other words, depending on how long ink remains inside the ink tube, the thickness level of ink retained in a recording head could be high. In like manner, the thickness level of ink remaining in nozzles could be high depending on the temperature and/or humidity of a print-execution environment or other factors. Even if the thickness level of ink remaining in nozzles is considerably high for the above-described reason, though not limited thereto, the movable line-head configuration of the printer 11 according to the present embodiment of the invention makes it possible to significantly reduce the adverse possibility of the clogging of nozzles just by performing flushing that is executed at each elapsing of normal flushing execution time.

(2) The first-line line head 12 moves together with the movable guide portion 36A of the movable guide member 36, which constitutes a part of the paper guide 34, as the movable guide portion 36A of the movable guide member 36 is moved in a sliding manner. Therefore, the printer 11 according to the present embodiment of the invention makes it possible to set the first-line line head 12 at a right position that is in accordance with the size of the sheet of printing paper 20 without requiring any dedicated or special power source and/or control thereof for moving the first-line line head 12.

(3) The paper guide 34 offers the aforementioned one-side slide paper adjustment. Therefore, it is possible to achieve the advantageous configuration of the printer 11 according to the present embodiment of the invention with a single movable line head, which is the first-line line head 12 in the exemplary embodiment of the invention, and an immovable/fixed line head, which is the second-line line head 13 in the exemplary embodiment of the invention. For example, if a center paper adjustment structure is adopted, it is necessary to configure both of the first-line line head 12 and the second-line line head 13 as movable line heads. The configuration of the printer 11 according to the present embodiment of the invention is advantageous over such a center-paper-adjustment configuration in that it is possible to reduce the number of movable components, which generally have a more complex structure than that of immovable components. Therefore, the printer 11 according to the present embodiment of the invention features a relatively simple structure.

(4) In addition to the first-line line head 12, the maintenance apparatus 23 also moves together with the movable guide portion 36A of the movable guide member 36, which constitutes a part of the paper guide 34, as the movable guide portion 36A of the movable guide member 36 is moved in a sliding manner. Therefore, the printer 11 according to the present embodiment of the invention makes it possible to perform flushing/cleaning easily no matter where the first-line line head 12 is positioned. If the maintenance apparatus 23 does not move together with the movable guide portion 36A of the movable guide member 36, the first-line line head 12 only moves, that is, not together with the cap 21 of the maintenance apparatus 23. In such a case, it is necessary to move the first-line line head 12 from a printing position to a maintenance position so as to perform flushing and/or cleaning. Since the movement of the maintenance apparatus 23 is also associated with the sliding movement of the movable guide portion 36A of the movable guide member 36, it is possible to eliminate need for any dedicated or special power source and/or control thereof for moving the maintenance apparatus 23. Therefore, the printer 11 according to the present embodiment of the invention features a relatively simple structure.

(5) The printer 11 according to the present embodiment of the invention is provided with the position sensor 58. The CPU 61 recognizes the nozzle-overlap area at which the nozzle lines 12B of the first-line head 12 and the nozzle lines 13B of the second-line head 13 overlap each other on the basis of a detection signal supplied from the position sensor 58. If the CPU 61 judges that there is such a nozzle-overlap area, ink-landing positions on a sheet of printing paper 20 are switched over between the first-line line head 12 and the second-line line head 13. Through the above-described nozzle switchover, both of the nozzles of the first-line line head 12 and the nozzles of the second-line line head 13 are used as the aforementioned active nozzles that are actually used for printing. As a result thereof, it is possible to effectively prevent the thickening of ink inside nozzles and thus further prevent the clogging of the nozzles.

(6) In the configuration of the printer 11 according to the present embodiment of the invention, active nozzles that are actually used for printing at the nozzle-overlap area at which the nozzle lines 12B of the first-line head 12 and the nozzle lines 13B of the second-line head 13 overlap each other are switched over between the nozzles of the first-line line head 12 and the nozzles of the second-line line head 13 at each time when print-target sheets of paper 20 are changed over due to the ejection of the current sheet of print-completed paper 20 and the feeding of the next sheet of printing paper 20. Because of such a configuration, all nozzles of the first-line line head 12 and the second-line line head 13 could be designated as ink-ejection nozzles with an increased ink-ejection opportunity. By this means, it is possible to effectively prevent the clogging of nozzles and other related problems. In addition, it is possible to simplify the control behavior of ink-discharging operation that is performed by each of the first-line line head 12 and the second-line line head 13 because the active nozzles are switched over at each time when print-target sheets of paper 20 are changed over.

Although a fluid ejecting apparatus having distinctively unique features of the present invention is described above while explaining preferred exemplary embodiments thereof, the invention should be in no case interpreted to be limited to the specific embodiments described above. The invention may be modified, altered, changed, adapted, and/or improved within a range not departing from the gist and/or spirit of the invention apprehended by a person skilled in the art from explicit and implicit description made herein, where such a modification, an alteration, a change, an adaptation, and/or an improvement is also covered by the scope of the appended claims. The followings are non-limiting examples of a modification, an alteration, a change, an adaptation, and/or an improvement of the preferred exemplary embodiments described above.

### Variation Example 1

The first-line line head 12, which is a non-limiting example of a fluid ejecting head according to the invention, may move not together with the movable guide portion 36A of the movable guide member 36 that constitutes a part of the paper guide 34. That is, the first-line line head 12 may move independently of the movable guide portion 36A of the movable guide member 36. For example, a dedicated power source for driving the first-line line head 12 may be provided so as to move the first-line line head 12. FIG. 12 illustrates a non-limiting example of such a modified configuration. As shown in FIG. 12, the controller 50 is electrically connected to an electric motor 68 via a motor driver 67 in addition to other aforementioned drivers illustrated in FIG. 11. The CPU 61 identifies the location of the movable guide portion 36A of the movable guide member 36 on the basis of a detection signal supplied from the position sensor 58. Then, the CPU 61 controls the driving operation of the electric motor 68 via the motor driver 67 so as to move the first-line line head 12 to a position that corresponds to the identified location of the movable guide portion 36A of the movable guide member 36. Or, in other words, the CPU 61 controls the driving operation of the electric motor 68 via the motor driver 67 so as to move the first-line line head 12 to a position that is in accordance with the width of a sheet of printing paper 20. With such a modified configuration, as a user slides the movable guide portion 36A of the movable guide member 36 in the paper-width Y direction, the first-line line head 12 moves to a right position that is in accordance with the size of a sheet of printing paper 20 as driven by the electric motor 68 under the control of the controller 50. By this means, the relative positions of the first-line line head 12 and the second-line line head 13 are set in accordance with the size of the sheet of printing paper 20. The modified configuration described above has an advantage in that a user can slide the movable guide portion 36A of the movable guide member 36 with a smaller force and thus easily. In addition, the modified configuration described above has another advantage in that, even when the user inadvertently touches the movable guide portion 36A of the movable guide member 36 during the execution of printing, it is possible to avoid the ink-ejection position of the first-line line head 12 from being displaced as a result of the unintended movement of the first-line line head 12 together with the inadvertent movement of the movable guide portion 36A of the movable guide member 36. In place of the full-manual (or full-automatic) configuration described above, a semi-manual configuration in which the first-line line head 12 moves together with the movable guide portion 36A of the movable guide member 36 as it (i.e., the movable guide portion 36A of the movable guide member 36) is moved manually whereas the maintenance apparatus 23 moves independently thereof as driven by a non-manual power source may be adopted. Another semi-manual configuration in which the maintenance apparatus 23 moves together with the movable guide portion 36A of the movable guide member 36 as it is moved manually whereas the first-line line head 12 moves independently thereof as driven by a non-manual power source may be adopted. The relative positions of the first-line line head 12 and the second-line line head 13 may be variable in accordance with printing conditions such as layout conditions, though not limited thereto. For example, the positional relationship between the first-line line head 12 and the second-line line head 13 may be variable in such a manner that the distance between the line head 12 and the line head 13 is relatively large at the time when borderless printing is performed. In such a modified configuration, the distance between the line head 12 and the line head 13 is relatively small at the time when non-borderless printing (i.e., printing with paper margin) is performed in comparison with the borderless-printing inter-line-head distance described above. By this means, regardless of whether borderless printing or non-borderless printing is performed, it is possible to position all nozzles inside the maximum printable area (i.e., maximum fluid ejectable range) that is dependent on the width of a sheet of printing paper 20 and layout conditions. As a result thereof, the number of nozzles from which ink drops are ejected only for flushing decreases. Therefore, such a modified configuration makes it possible to further effectively prevent or reduce the clogging of nozzles. A combination of the motor driver 67 and the electric motor 68 is a non-limiting example of a “driving section” according to the invention. The controller 50, or, more specifically, the CPU 61 thereof, is a non-limiting example of a “controlling section” according to the invention.

### Variation Example 2

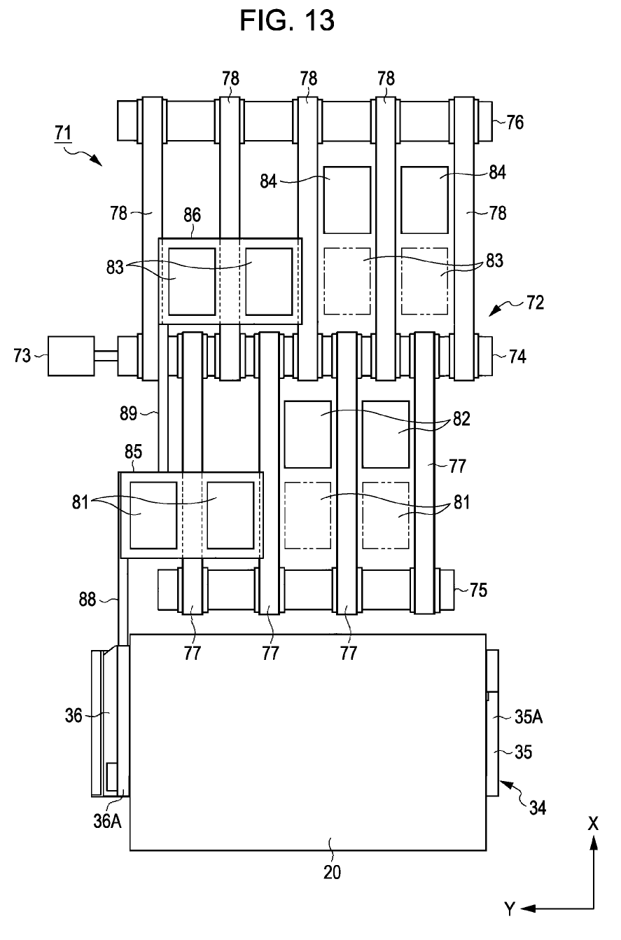

The invention may be applied to a line printer that has a plurality of recording heads arranged in a staggered pattern as shown in FIG. 13. In the configuration of a line-type printer 71 shown in FIG. 13, for example, a paper-transport unit 72 that transports a sheet of printing paper 20 is provided. The paper-transport unit 72 conforms to an electrostatic-chuck belt operation scheme. The sheet of printing paper 20 is a non-limiting example of a fluid ejection target medium according to the invention. The paper-transport unit 72 is made up of, though not necessarily limited thereto, an electric motor 73, three rollers 74, 75, and 76, and paper-transport belts 77 and 78. As the electric motor 73 is driven, the paper-transport belts 77 and 78 turn. As a result of the turning of the paper-transport belts 77 and 78, a sheet of printing paper 20 that is fed from the paper guide 34 is transported over the paper-transport belts 77 and 78 in the paper-transport X direction. Four paper-transport belts 77 are wound around an upstream pair of the rollers 74 and 75. It should be noted that the lower side of FIG. 13 corresponds to the upstream side as viewed along the paper-transport X direction. A pair of movable recording heads 81 as well as a pair of immovable (i.e., fixed) recording heads 82 is arranged in such a manner that the movable recording head 81 or the immovable recording head 82 is provided at a gap region between adjacent two of these four paper-transport belts 77. The pair of movable recording heads 81 is configured as a first-line recording heads, whereas the pair of immovable recording heads 82 is configured as a second-line recording heads. Five paper-transport belts 78 are wound around a downstream pair of the rollers 74 and 76. It should be noted that that the upper side of FIG. 13 corresponds to the downstream side as viewed along the paper-transport X direction. A pair of movable recording heads 83 as well as a pair of immovable recording heads 84 is arranged in such a manner that the movable recording head 83 or the immovable recording head 84 is provided at a gap region between adjacent two of these five paper-transport belts 78. The pair of movable recording heads 83 is configured as a third-line recording heads, whereas the pair of immovable recording heads 84 is configured as a fourth-line recording heads. The pair of immovable recording heads 82 that constitutes the second line is shifted from the pair of immovable recording heads 84 that constitutes the fourth line by a half head pitch as viewed along the paper-width Y direction. Having such a half-pitch-shifted array of the immovable recording heads 82 and 84, the line printer 71 according to the second variation example of the invention described herein features a nozzle array that makes it possible to perform printing on a sheet of printing paper 20 without leaving any space as viewed along the paper-width Y direction by means of the second-line immovable recording heads 82 and the fourth-line immovable recording heads 84. The pair of movable recording heads 81 that constitutes the first line is mounted on a supporting member 85. The pair of movable recording heads 83 that constitutes the third line is mounted on a supporting member 86. The pair of first-line movable recording heads 81 is arrayed on the supporting member 85 with a fixed head pitch therebetween as viewed along the paper-width Y direction. The pair of third-line movable recording heads 83 is arrayed on the supporting member 86 with a fixed head pitch therebetween as viewed along the paper-width Y direction. A coupling rod 88 extends in the paper-transport X direction from the movable guide portion 36A of the movable guide member 36, which constitutes a part of the paper guide 34. The front end of the coupling rod 88 is fixed to the first-line supporting member 85. Another coupling rod 89 extends in the paper-transport X direction from the first-line supporting member 85. The front end of the coupling rod 89 is fixed to the third-line supporting member 86. Each of the coupling rods 88 and 89 is connected to a maintenance apparatus either directly or via a coupling member (i.e., indirectly). The maintenance apparatuses, which are not shown in the drawing, are provided under the recording heads 81, 82, 83, and 84 so as to face the recording heads 81, 82, 83, and 84, respectively. It should be noted that the maintenance apparatuses are not shown in the drawing. The recording heads 81, 82, 83, and 84 move together with the maintenance apparatuses.

As a user slides the movable guide portion 36A of the movable guide member 36 in the paper-width Y direction in accordance with the width size of a sheet of printing paper 20, the pair of first-line movable recording heads 81 and the pair of third-line movable recording heads 83 move together with the movable guide portion 36A of the movable guide member 36 in the paper-width Y direction while maintaining the respective head pitches. At the time when the movable guide portion 36A of the movable guide member 36 is moved to the minimum-sheet-size position, the pair of first-line movable recording heads 81 and the pair of third-line movable recording heads 83 are moved to positions illustrated in FIG. 13 by alternate long and two short dashes lines, respectively. As a result thereof, at the time when the movable guide portion 36A of the movable guide member 36 is moved to the minimum-sheet-size position, the nozzle lines of the pair of first-line movable recording heads 81 completely overlap the nozzle lines of the pair of second-line immovable recording heads 82 when viewed along the paper-transport X direction. In addition, at the time when the movable guide portion 36A of the movable guide member 36 is moved to the minimum-sheet-size position, the nozzle lines of the pair of third-line movable recording heads 83 completely overlap the nozzle lines of the pair of fourth-line immovable recording heads 84 when viewed along the paper-transport X direction. A controller (CPU) performs ink-discharging control by means of the same control method as that described in the foregoing exemplary embodiments of the invention. That is, the controller makes an active-nozzle switchover between the first-line recording heads 81 and the third-line recording heads 83 as well as between the second-line recording heads 82 and the fourth-line recording heads 84 at the nozzle-overlap area. If the invention is applied to a line printer that has a plurality of recording heads arranged in a staggered pattern as described above, it is possible to obtain the same advantageous effects as those offered by the foregoing exemplary embodiments of the invention. It should be noted that the number of lines of recording heads is not limited to four. As a modified configuration of the above, for example, the number of lines of recording heads may be six, eight, ten or more.

### Variation Example 3

The execution timing of flushing operation may be variable. For example, if there is not any nozzle that did not discharge ink drops even once during the flushing execution time interval, or, in other words, until the flushing set time elapses, the flushing execution time may be extended. If such a modified configuration is adopted, it is possible to defer the flushing execution timing so as to decrease the number of times of flushing operations. By this means, it is possible to narrow a paper gap that was preset (i.e., allocated) to be wide enough so as to allow flushing to be executed. In addition to or in place of the narrowing of a paper gap described above, it is possible to increase paper-feed speed that was preset to be slow enough so as to allow flushing to be executed. As a result thereof, it is possible to enhance the throughput of printing.

### Variation Example 4

In the configuration of the printer 11 according to the foregoing exemplary embodiment of the invention, the paper guide 34 has the guide support member 35 having the fixed guide portion 35A and the movable guide member 36 having the movable guide portion 36A. Having such a structure, the paper guide 34 according to the foregoing exemplary embodiment of the invention offers the aforementioned one-side slide paper adjustment. However, the scope of the invention is not limited to such a specific exemplary configuration. For example, a paper guide that has the aforementioned center paper adjustment structure may be adopted. In the configuration of a center-paper-adjustment paper guide, both sides of guide portions thereof can move while keeping a center unchanged therebetween. If the configuration of such a center-paper-adjustment paper guide is adopted, the line head 12 is fixed to one of the movable guide portions in such a manner that the line head 12 can move together with the above-mentioned one of the movable guide portions whereas the line head 13 is fixed to the other of the movable guide portions in such a manner that the line head 13 can move together with the above-mentioned other of the movable guide portions. At the time when a sheet of printing paper having the maximum sheet size is set on the paper guide, the nozzle-overlap area at which the nozzle lines 12B of the line head 12 and the nozzle lines 13B of the line head 13 overlap each other takes the minimum value, which might be zero but not limited thereto. As a gap between the above-mentioned one of the movable guide portions and the other thereof narrows, the nozzle-overlap area at which the nozzle lines 12B of the line head 12 and the nozzle lines 13B of the line head 13 overlap each other increases.

### Variation Example 5

The invention is applicable as long as the N number (N>2) of fluid ejecting heads is provided and if, for example, the (N−1) number of fluid ejecting heads can move in a direction orthogonal to the transport direction of a fluid ejection target medium. The number N may be two, three or more. It should be noted that the number of fluid ejecting heads that can move in a direction orthogonal to the transport direction of a fluid ejection target medium is not limited to (N−1). That is, the invention is applicable as long as the number of fluid ejecting heads that can move in a direction orthogonal to the transport direction of a fluid ejection target medium is at least one.

### Variation Example 6

In the configuration of the printer 11 according to the foregoing exemplary embodiment of the invention, it is explained that the nozzle-switchover conditions for switching over active nozzles that are actually used for printing between the first-line line head 12 and the second-line line head 13 at the nozzle-overlap area are set as the changing of print-target sheets of paper 20 due to the ejection of the current sheet of print-completed paper 20 and the feeding of the next sheet of printing paper 20. Notwithstanding the foregoing, however, the nozzle-switchover conditions may not be associated with the changing of print-target sheets of paper 20. For example, the active nozzles may be switched over once or a plural number of times during the execution of printing on a single sheet (i.e., page) of printing paper. For example, ink-landing positions on a sheet of printing paper 20 may be shifted from each other between the first-line line head 12 and the second-line line head 13.

### Variation Example 7

The sizes (i.e., lengths of nozzle lines) of fluid ejecting heads measured along the direction orthogonal to the paper-transport X direction may differ from each other (or differ from one to another). The following is a non-limiting preferable example of a combination of two fluid ejecting heads that have sizes different from each other. One of two fluid ejecting heads has a size corresponding to the width of printing paper having the minimum sheet size (e.g., L paper size). The other of two fluid ejecting heads has a size corresponding to the width of printing paper having a sheet size that is equal to a difference between a regular sheet size (e.g., A4 paper size), which is larger than the minimum sheet size, and the minimum sheet size (i.e., A4 paper size-L paper size). The above-described combination of two fluid ejecting heads that have sizes different from each other offers a preferable combination head size (i.e., the lengths of nozzle lines) that ensures that the nozzle-line overlap is minimized at the time when printing is performed on a sheet of printing paper having a regular sheet size.

### Variation Example 8

In the configuration of the printer 11 according to the foregoing exemplary embodiment of the invention, it is explained that a fluid ejecting head and a cap move together. However, the scope of the invention is not limited to such an exemplary configuration. For example, a fluid ejecting head only may be movable. If the cap is provided as an immovable part, the fluid ejecting head is moved to a standby position where the cap is provided at each time when flushing or cleaning is performed and at each time when the fluid ejecting head is capped so as to wait till the next execution of printing.

### Variation Example 9

The type of a printer that constitutes a non-limiting example of a fluid ejecting apparatus according to the invention is not limited to a line printer. For example, the invention can be applied to a serial printer, which performs printing while moving (i.e., scanning) its recording heads in the paper-width direction. If the invention is applied to a serial printer, printing operation is performed as follows. At the time when printing is performed on a sheet of printing paper having the maximum sheet size, the relative positions of the fluid ejecting heads thereof are set in such a manner that they are distanced from each other with the maximum distance therebetween. This means that the overlap of the fluid ejecting heads is minimized at the time when printing is performed on a sheet of printing paper having the maximum sheet size. With such positional setting of the fluid ejecting heads, the serial printer performs printing on a sheet of printing paper having the maximum sheet size while moving the fluid ejecting heads in the paper-width direction, which is the main scan direction. On the other hand, at the time when printing is performed on a sheet of printing paper having the minimum sheet size, the fluid ejecting heads thereof are positioned close to each other in such a manner that they at least partially overlap each other when viewed in the paper-transport direction. With such positional setting of the fluid ejecting heads, the serial printer performs printing on a sheet of printing paper having the minimum sheet size while functioning as a line printer. The example of a fluid ejecting apparatus having a function of a serial printer described above offers the same advantageous effects as those offered by the foregoing exemplary embodiments of the invention.

### Variation Example 10

In the configuration of the printer 11 according to the foregoing exemplary embodiment of the invention, it is explained that a fluid ejecting apparatus is embodied as an ink-jet recording apparatus. However, the scope of the invention is not limited to such an exemplary configuration. For example, the invention is applicable to a variety of fluid ejecting apparatuses that ejects or discharges various kinds of fluid that includes ink but not limited thereto. For example, the scope of the invention covers, without any limitation thereto, a liquid ejecting apparatus that is provided with a liquid ejecting head that ejects liquid onto a liquid ejection target medium, and in addition thereto, a liquid ejection control method that is used by such a liquid ejecting apparatus. The invention is further applicable to a fluid ejecting apparatus (and a fluid ejection control method) that ejects a liquid/liquefied matter/material that is made as a result of dispersion or mixture of particles of functional material(s) into/with liquid. The invention is further applicable to a fluid ejecting apparatus (and a fluid ejection control method) that ejects a gel substance. The invention is further applicable to a fluid ejecting apparatus (and a fluid ejection control method) that ejects a semi-solid substance that can be ejected as a fluid. It should be noted that the scope of the invention is not limited to those enumerated above. In addition to an ink-jet recording apparatus described in the foregoing exemplary embodiment of the invention, a fluid ejecting apparatuses to which the invention is applicable encompasses a wide variety of other types of apparatuses that ejects liquid or fluid in which, for example, a color material (pixel material) or an electrode material is dispersed or dissolved, though not necessarily limited thereto. Herein, the color material may be, for example, one that is used in the production of color filters for a liquid crystal display device or the like. The electrode material (i.e., conductive paste) may be, though not limited thereto, one that is used for electrode formation of an organic EL display device, a surface/plane emission display device (FED), and the like. A fluid ejecting apparatuses to which the invention is applicable further encompasses a wide variety of other types of apparatuses such as one that ejects a living organic material used for production of biochips or one that is provided with a sample ejection head functioning as a high precision pipette and ejects liquid as a sample therefrom. Further in addition, the invention is applicable to, and thus can be embodied as, a liquid ejecting apparatus that ejects, with high precision, lubricating oil onto a precision instrument and equipment including but not limited to a watch and a camera. Moreover, the invention is applicable to and thus can be embodied as a liquid ejecting apparatus that ejects liquid of a transparent resin such as an ultraviolet ray curing resin or the like onto a substrate so as to form a micro hemispherical lens (optical lens) that is used in an optical communication element or the like. Furthermore, the invention is applicable to and thus can be embodied as a liquid ejecting apparatus that ejects an etchant such as acid or alkali that is used for the etching of a substrate or the like. Further in addition, the invention is applicable to and thus can be embodied as a fluid ejecting apparatus that ejects a gel fluid (e.g., physical gel). In the description of this specification and the recitation of appended claims, the term “fluid” is defined as a broad generic concept that encompasses a variety of fluid matter/material/substance that includes but not limited to liquid matter/material/substance. Only one exception thereof is “gas-only” fluid (i.e., fluid that is made up of gas only). For example, the fluid includes, without any limitation thereto, inorganic solvent, organic solvent, solution, liquid resin, and liquid metal (e.g., metal melt).

The following is one aspect of the technical concept of the invention that can be understood from the foregoing exemplary embodiments of the invention and variation examples thereof described above.

(1) That is, without any intention to limit the scope of any of appended claims, as one aspect of the technical concept thereof, the invention can be defined as a fluid ejecting apparatus that is provided with a plurality of fluid ejecting heads that can eject a fluid onto a fluid ejection target medium and further has the following features. At the time when the plurality of fluid ejecting heads ejects the fluid onto the fluid ejection target medium, the positions of the plurality of fluid ejecting heads as viewed in a predetermined direction that intersects the transport direction of the fluid ejection target medium are fixed. In addition, at least one of the plurality of fluid ejecting heads can move in the predetermined direction that intersects the transport direction of the fluid ejection target medium so as to adjust the relative positions of the plurality of fluid ejecting heads as viewed in the predetermined direction that intersects the transport direction of the fluid ejection target medium in preparation for the ejection of the fluid onto the fluid ejection target medium. The above-described configuration applies to a line-type fluid ejecting apparatus, which is one example of the invention. The line-type fluid ejecting apparatus having the configuration described above makes it possible to effectively prevent, or at least reduce, the clogging of nozzles of fluid ejecting heads and other related problems while reducing any wasteful consumption of fluid other than for the purpose of ejection thereof onto a fluid ejection target medium.

What is claimed is:

1. A fluid ejecting apparatus comprising:
an apparatus body; and
a plurality of fluid ejecting heads that can eject fluid onto a fluid ejection target medium;
wherein at least one of the plurality of fluid ejecting heads can move in a predetermined direction that intersects the transport direction of the fluid ejection target medium so as to change the relative positions of the plurality of fluid ejecting heads as viewed in the predetermined direction that intersects the transport direction of the fluid ejection target medium.

2. The fluid ejecting apparatus according to claim 1, further comprising: a movable guiding section that can move so as to determine the position of the fluid ejection target medium as viewed in the predetermined direction that intersects the transport direction of the fluid ejection target medium; wherein the above-mentioned at least one of the plurality of fluid ejecting heads that can move in the predetermined direction that intersects the transport direction of the fluid ejection target medium moves together with the movable guiding section.

3. The fluid ejecting apparatus according to claim 2, wherein one edge of the fluid ejection target medium as viewed in the direction of the width of the fluid ejection target medium is taken as a guide basis; and the movable guiding section can move in such a manner that the movable guiding section guides the other opposite edge of the fluid ejection target medium as viewed in the width direction of the fluid ejection target medium.

4. The fluid ejecting apparatus according to claim 1, further comprising a plurality of caps that are used for capping the plurality of fluid ejecting heads, respectively, wherein the cap that corresponds to, or the caps that correspond to, the above-mentioned at least one of the plurality of fluid ejecting heads that can move in the predetermined direction that intersects the transport direction of the fluid ejection target medium can move together with the above-mentioned at least one of the plurality of fluid ejecting heads.

5. The fluid ejecting apparatus according to claim 1, further comprising: a detecting section that can detect the position of the above-mentioned at least one movable fluid ejecting head as viewed in the predetermined direction that intersects the transport direction of the fluid ejection target medium; and a controlling section that identifies an overlapping area at which the plurality of fluid ejecting heads overlap each other or one another as viewed in the transport direction of the fluid ejection target medium in a fluid ejectable range on the basis of the detection result of the detecting section and then controls the operation of the plurality of fluid ejecting heads in such a manner that overlapping two or more fluid ejecting heads eject fluid in the identified overlapping area while shifting fluid landing positions on the fluid ejection target medium therebetween or thereamong.

6. The fluid ejecting apparatus according to claim 5, wherein the controlling section switches over fluid ejecting heads for ejection of fluid at the identified overlapping area at each time when the fluid ejection target media are changed over.

7. The fluid ejecting apparatus according to claim 5, further comprising a driving section that moves the above-mentioned at least one movable fluid ejecting head in the predetermined direction that intersects the transport direction of the fluid ejection target medium, wherein the detecting section can detect the movement position of the movable guiding section; and the controlling section controls the driving operation of the driving section on the basis of the detection result of the detecting section so as to move the above-mentioned at least one movable fluid ejecting head to a position that is in accordance with the width of the fluid ejection target medium.

8. A fluid ejection control method that is used by a fluid ejecting apparatus, the fluid ejecting apparatus having a plurality of fluid ejecting heads that can eject fluid onto a fluid ejection target medium, at least one of the plurality of fluid ejecting heads being able to move in a predetermined direction that intersects the transport direction of the fluid ejection target medium so as to change the relative positions of the plurality of fluid ejecting heads as viewed in the predetermined direction that intersects the transport direction of the fluid ejection target medium, the fluid ejection control method comprising:
moving the above-mentioned at least one movable fluid ejecting head to a position so as to position all nozzles inside the maximum fluid ejectable range that is determined by the size of the fluid ejection target medium; and
controlling, if there is an overlapping area at which the fluid ejectable ranges of the plurality of fluid ejecting heads overlap each other or one another as viewed in the transport direction of the fluid ejection target medium, the plurality of fluid ejecting heads in such a manner that overlapping two or more fluid ejecting heads eject fluid in the overlapping area while shifting fluid landing positions on the fluid ejection target medium therebetween or thereamong.
